(19) United States
(12) Patent Application Publication
(10) Pub. No.: US 2026/0162901 A1
(43) Pub. Date: Jun. 11, 2026

(54) MULTILAYER CERAMIC CAPACITOR

(71) Applicant: Murata Manufacturing Co., Ltd., Nagaokakyo-shi (JP)

(72) Inventors: Takashi SAWADA, Nagaokakyo-shi (JP); Kazunori USUI, Nagaokakyo-shi (JP); Masahiro SAKURATANI, Nagaokakyo-shi (JP)

(21) Appl. No.: 19/387,919

(22) Filed: Nov. 13, 2025

(30) Foreign Application Priority Data
Dec. 10, 2024 (JP) 2024-215366

(51) Int. Cl. H01G 4/248; H01G 2/06; H01G 4/12; H01G 4/232; H01G 4/30

(52) U.S. Cl. CPC H01G 4/248; H01G 2/065; H01G 4/12; H01G 4/232; H01G 4/30

(57) ABSTRACT

A multilayer ceramic capacitor includes a multilayer body including dielectric layers, inner electrode layers on the dielectric layers, first through sixth surfaces, a first inner electrode layer on the dielectric layers and extended to the third and fourth surfaces, a second inner electrode layer on the dielectric layers and extended to the fifth and sixth surfaces, a first outer electrode on the third surface and connected to the first inner electrode layer, a second outer electrode on the fourth surface and connected to the first inner electrode layer, a third outer electrode on the fifth surface and connected to the second inner electrode layer, and a fourth outer electrode on the sixth surface and connected to the second inner electrode layer. The first outer electrode includes a first turn-up portion and the second outer electrode includes a second turn-up portion, each covering portions of the fifth and sixth surfaces.

### CROSS REFERENCE TO RELATED APPLICATIONS

This application claims the benefit of priority to Japanese Patent Application No. 2024-215366 filed on Dec. 10, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

A through-connection multilayer ceramic capacitor is known as a decoupling capacitor for stabilizing a power supply voltage fed to an integrated circuit component (IC) that operates at a high speed or as a noise-control component for a power line. A through-connection multilayer ceramic capacitor generally includes a ceramic base (dielectric base) having outer surfaces including first and second main surfaces opposing each other, first and second side surfaces opposing each other, and first and second end surfaces opposing each other. Inside the ceramic base, multiple first inner electrodes and multiple second inner electrodes are alternately disposed in a lamination direction. Each first inner electrode has both ends extended to the first end surface and the second end surface and connected to first and second outer electrodes located on both end surfaces. Each second inner electrode has both ends extended to the first side surface and the second side surface and connected to third and fourth outer electrodes located on both side surfaces.

Recent size reduction of electronic devices restricts a space available for mounting a through-connection multilayer ceramic capacitor on a circuit board. To reduce a mount area, the through-connection multilayer ceramic capacitor having a smaller dimension in the lamination direction than a dimension in the height direction may be vertically mounted while having the first side surface or the second side surface facing the circuit board. Such an electronic device is described in Japanese Unexamined Patent Application Publication No. 2003-22932.

### SUMMARY OF THE INVENTION

However, when the through-connection multilayer ceramic capacitor is vertically mounted, a chip may be inclined depending on the height relationship between the outer electrodes on the side surfaces and turn-up portions of the outer electrodes on the end surfaces.

Accordingly, example embodiments of the present invention provide multilayer ceramic capacitors that each can be stably mounted on a mount board while remaining nearly untilted.

A multilayer ceramic capacitor according to an example embodiment of the present invention includes a multilayer body including a plurality of laminated dielectric layers, and a plurality of inner electrode layers laminated on the dielectric layers, the multilayer body including a first surface and a second surface opposing in a lamination direction, a third surface and a fourth surface opposing in a first direction orthogonal to the lamination direction, and a fifth surface and a sixth surface opposing in a second direction orthogonal to the lamination direction and the first direction, a first inner electrode layer on the plurality of dielectric layers and extended to the third surface and the fourth surface, a second inner electrode layer on the plurality of dielectric layers and extended to the fifth surface and the sixth surface, a first outer electrode on the third surface and connected to the first inner electrode layer, a second outer electrode on the fourth surface and connected to the first inner electrode layer, a third outer electrode on the fifth surface and connected to the second inner electrode layer, and a fourth outer electrode on the sixth surface and connected to the second inner electrode layer, wherein the first outer electrode includes a first turn-up portion covering a portion of the fifth surface and a portion of the sixth surface, the second outer electrode includes a second turn-up portion covering a portion of the fifth surface and a portion of the sixth surface, the fifth surface or the sixth surface faces a board mount surface, and, in the multilayer ceramic capacitor, (i) the first turn-up portion in the first outer electrode on the fifth surface includes a first thickest point or a thickest portion with a largest dimension in the second direction, the second turn-up portion in the second outer electrode on the fifth surface includes a second thickest point or a thickest portion with a largest dimension in the second direction, and the third outer electrode includes a third thickest point or a thickest portion with a largest dimension in the second direction, and a shortest distance between a line connecting the first thickest point of the first turn-up portion and the second thickest point of the second turn-up portion and the third thickest point of the third outer electrode located closer to the first surface or the second surface in the lamination direction is greater than or equal to about 50 μm, and/or (ii) the first turn-up portion in the first outer electrode on the sixth surface includes a first thickest point or a thickest portion with a largest dimension in the second direction, the second turn-up portion in the second outer electrode on the sixth surface includes a second thickest point or a thickest portion with a largest dimension in the second direction, and the fourth outer electrode includes a fourth thickest point or a thickest portion with a largest dimension in the second direction, and a shortest distance between a line connecting the first thickest point of the first turn-up portion and the second thickest point of the second turn-up portion and the fourth thickest point of the fourth outer electrode located closer to the first surface or the second surface in the lamination direction is greater than or equal to about 50 μm.

In a multilayer ceramic capacitor according to an example embodiment of the present invention, the multilayer ceramic capacitor includes a first thickest point of the first outer electrode or a thickest portion of the first turn-up portion on the fifth surface with a largest dimension in the second direction, a second thickest point of the second outer electrode or a thickest portion of the second turn-up portion on the fifth surface with a largest dimension in the second direction, and a third thickest point of the third outer electrode or a thickest portion in the third outer electrode with a largest dimension in the second direction, wherein a shortest distance between a line connecting the first thickest point of the first turn-up portion and the second thickest point of the second turn-up portion and the third thickest point of the third outer electrode located closer to the first surface or the second surface in the lamination direction is greater than or equal to about 50 μm, for example. Thus, when the multilayer ceramic capacitor is to be mounted on the mount board while the fifth surface on which the three thickest points are located defines and functions as the mount surface, an inclination is reduced to a relatively low level and thus the multilayer ceramic capacitor can be stably mounted while remaining nearly untilted.

In a multilayer ceramic capacitor according to an example embodiment of the present invention, a multilayer ceramic capacitor includes a first thickest point of the first outer electrode or a thickest portion of the first turn-up portion on the sixth surface with a largest dimension in the second direction, a second thickest point of the second outer electrode or a thickest portion of the second turn-up portion on the sixth surface with a largest dimension in the second direction, and a fourth thickest point of the fourth outer electrode or a thickest portion in the fourth outer electrode with a largest dimension in the second direction, wherein a shortest distance between a line connecting the first thickest point of the first turn-up portion and the second thickest point of the second turn-up portion and the fourth thickest point of the fourth outer electrode located closer to the first surface or the second surface in the lamination direction is greater than or equal to about 50 μm, for example. Thus, when the multilayer ceramic capacitor is to be mounted on the mount board while the sixth surface on which the three thickest points are disposed defines and functions as the mount surface, an inclination is reduced to a relatively low level and thus the multilayer ceramic capacitor can be stably mounted while remaining nearly untilted.

Example embodiments of the present invention provide multilayer ceramic capacitors that each can be stably mounted on a mount board while remaining nearly untilted.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of an example of a multilayer ceramic capacitor serving as a multilayer ceramic electronic component according to a first example embodiment of the present invention.

FIG. 2 is a bottom view of an example of the multilayer ceramic capacitor according to the first example embodiment of the present invention.

FIG. 3 is a top view of an example of the multilayer ceramic capacitor according to the first example embodiment of the present invention.

FIG. 4 is a front view of an example of the multilayer ceramic capacitor according to the first example embodiment of the present invention.

FIG. 5 is a side view of an example of the multilayer ceramic capacitor according to the first example embodiment of the present invention.

FIG. 6 is a cross-sectional view of the multilayer ceramic capacitor taken along line VI-VI in FIG. 4.

FIG. 7 is a cross-sectional view of the multilayer ceramic capacitor taken along line VII-VII in FIG. 4.

FIG. 8 is a cross-sectional view of the multilayer ceramic capacitor taken along line VIII-VIII in FIG. 5.

FIG. 9 is a cross-sectional view of the multilayer ceramic capacitor taken along line IX-IX in FIG. 5.

FIG. 10 is an external perspective view of a multilayer ceramic capacitor according to a second example embodiment of the present invention.

FIG. 11 is a right side view of an example of the multilayer ceramic capacitor according to the second example embodiment of the present invention.

FIG. 12 is a front view of an example of the multilayer ceramic capacitor according to the second example embodiment of the present invention.

FIG. 13 is a bottom view of an example of the multilayer ceramic capacitor according to the second example embodiment of the present invention.

FIG. 14 is a schematic cross-sectional view of the multilayer ceramic capacitor taken along line XIV-XIV in FIG. 11.

FIG. 15 is a schematic cross-sectional view of the multilayer ceramic capacitor taken along line XV-XV in FIG. 11.

FIG. 16 is a schematic cross-sectional view of the multilayer ceramic capacitor taken along line XVI-XVI in FIG. 12.

FIG. 17 is a schematic cross-sectional view of the multilayer ceramic capacitor taken along line XVII-XVII in FIG. 12.

FIG. 18 is a perspective view of inner electrode layers disposed in a multilayer body of the multilayer ceramic capacitor according to the second example embodiment of the present invention.

FIG. 19 is a diagram illustrating a method for measuring an inclination of each test piece in an example experiment.

### DETAILED DESCRIPTION OF THE EXAMPLE EMBODIMENTS

Multilayer ceramic capacitors according to example embodiments of the present invention are described. A multilayer ceramic capacitor 10 according to an example embodiment of the present invention is a through-connection multilayer ceramic capacitor (a three-terminal multilayer ceramic capacitor).

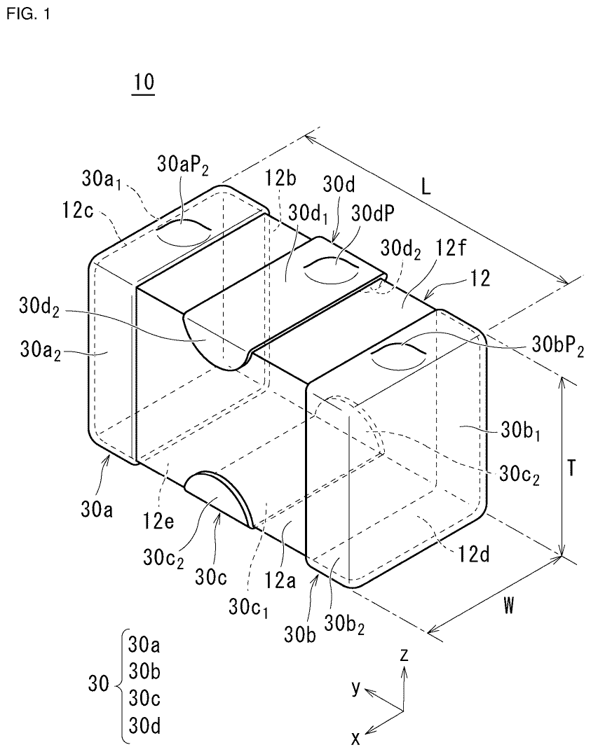

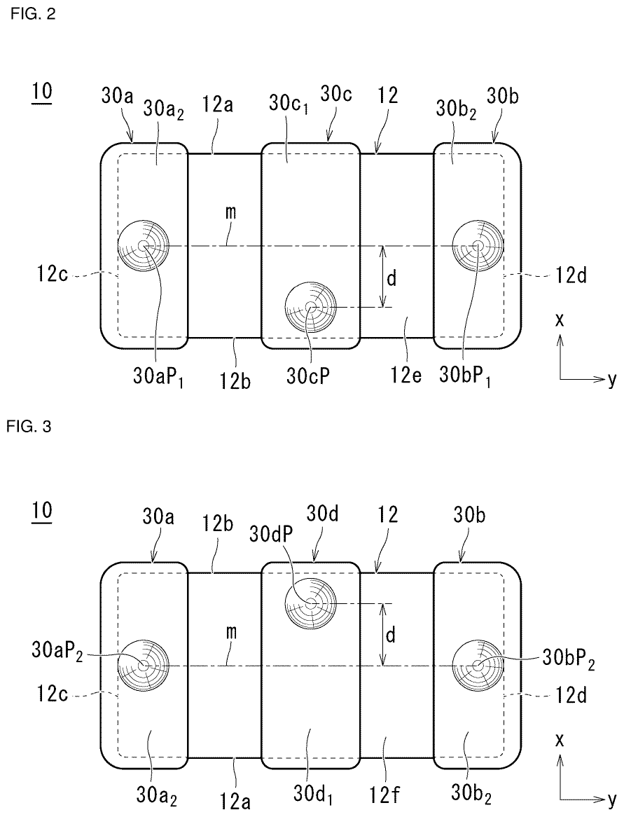

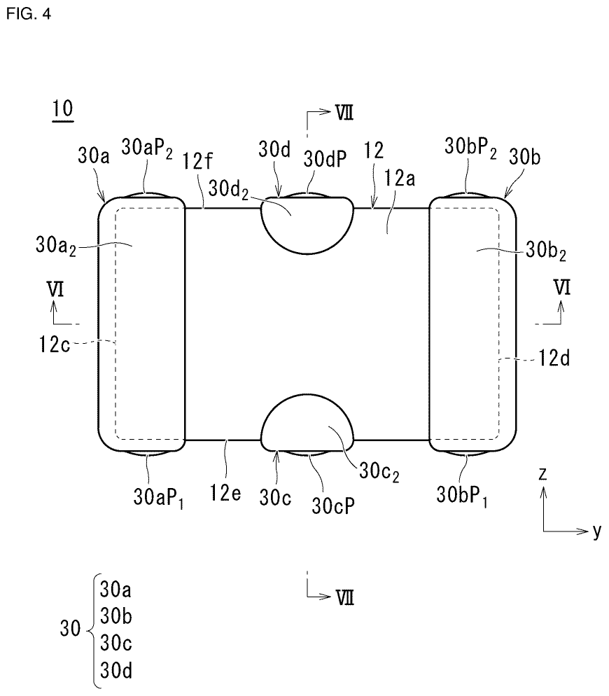

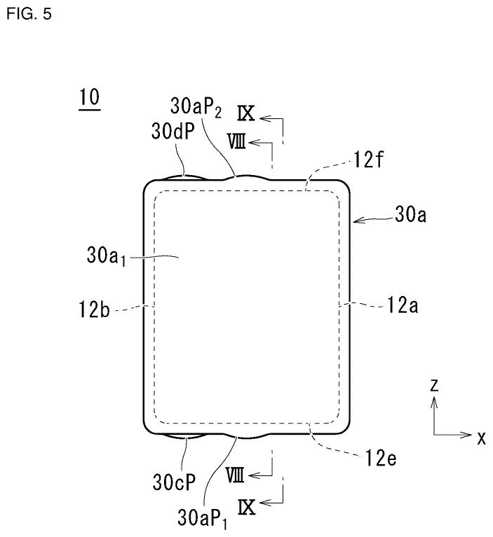

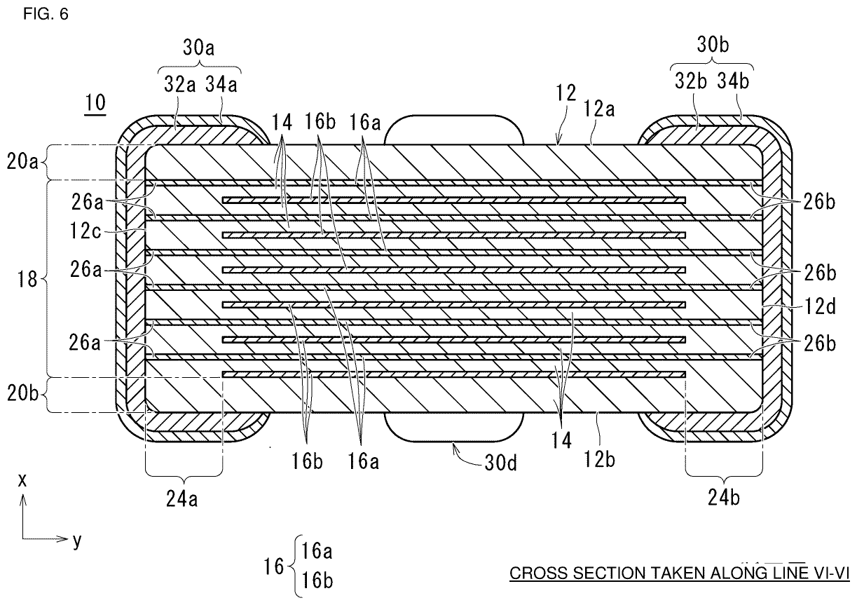

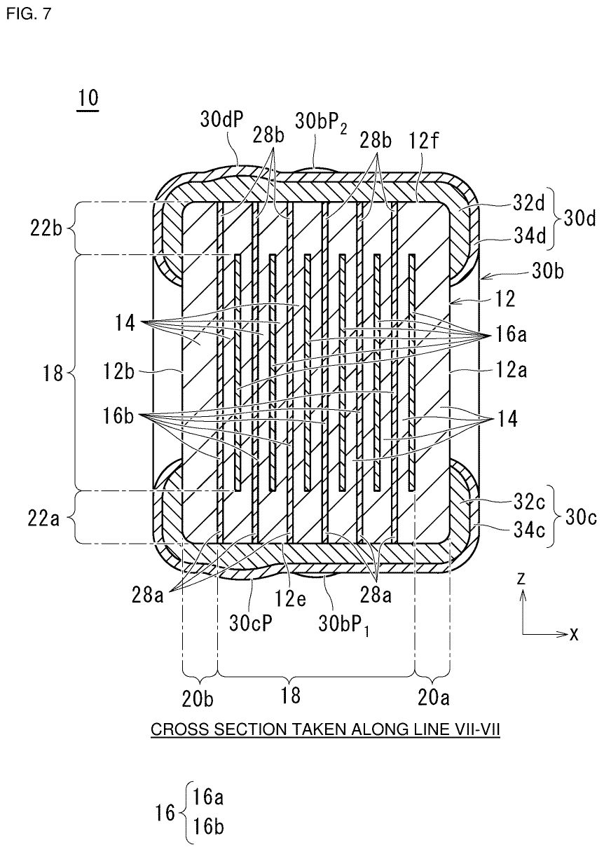

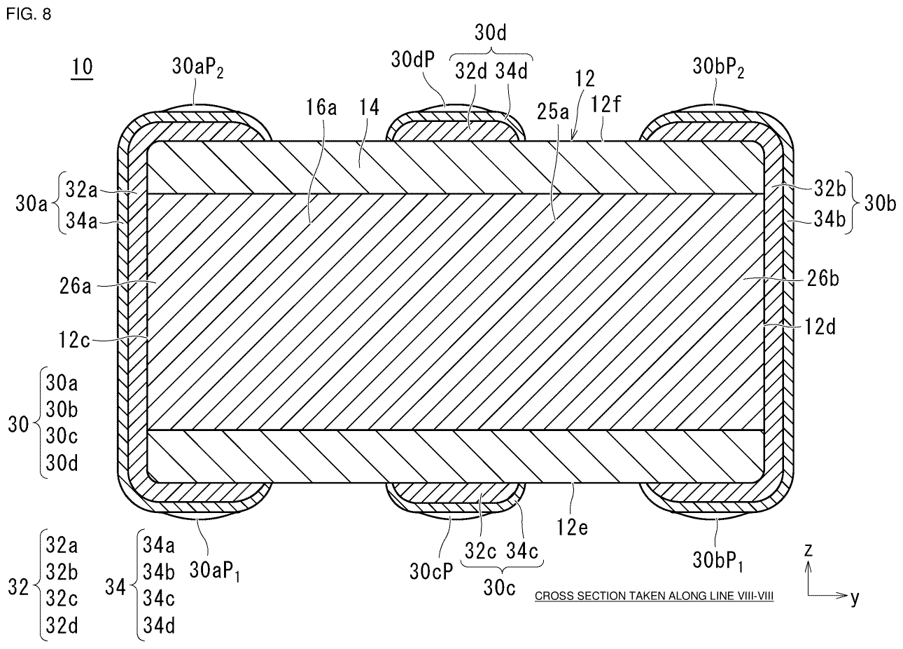

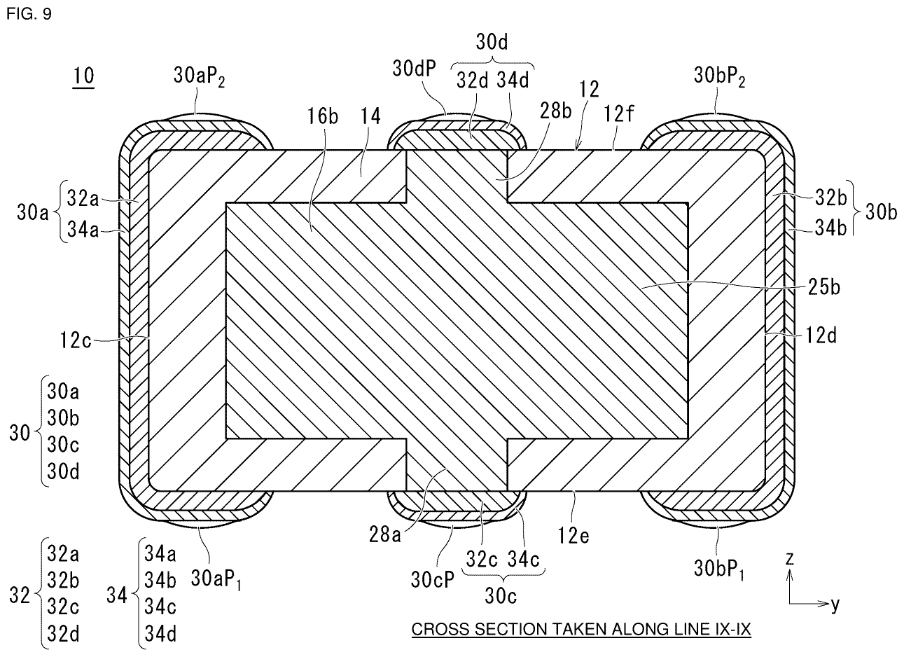

FIG. 1 is an external perspective view of an example of a multilayer ceramic capacitor serving as a multilayer ceramic electronic component according to a first example embodiment of the present invention. FIG. 2 is a bottom view of an example of the multilayer ceramic capacitor according to the first example embodiment of the present invention. FIG. 3 is a top view of an example of the multilayer ceramic capacitor according to the first example embodiment of the present invention. FIG. 4 is a front view of an example of the multilayer ceramic capacitor according to the first example embodiment of the present invention. FIG. 5 is a side view of an example of the multilayer ceramic capacitor according to the first example embodiment of the present invention. FIG. 6 is a cross-sectional view of the multilayer ceramic capacitor taken along line VI-VI in FIG. 4. FIG. 7 is a cross-sectional view of the multilayer ceramic capacitor taken along line VII-VII in FIG. 4. FIG. 8 is a cross-sectional view of the multilayer ceramic capacitor taken along line VIII-VIII in FIG. 5. FIG. 9 is a cross-sectional view of the multilayer ceramic capacitor taken along line IX-IX in FIG. 5.

As illustrated in FIG. 1 to FIG. 9, the multilayer ceramic capacitor 10 includes, for example, a multilayer body 12 and outer electrodes 30.

The multilayer body 12 includes multiple laminated dielectric layers 14 and multiple inner electrode layers 16 laminated on the dielectric layers 14. The inner electrode layers 16 include first inner electrode layers 16a and second inner electrode layers 16b. The first inner electrode layers 16a and the second inner electrode layers 16b are described in detail later.

The multilayer body 12 includes a first surface 12a and a second surface 12b opposing in a lamination direction x, a third surface 12c and a fourth surface 12d opposing in a first direction y orthogonal to the lamination direction x, and a fifth surface 12e and a sixth surface 12f opposing in a second direction z orthogonal to the lamination direction x and the first direction y.

The multilayer body 12 has a rectangular or substantially rectangular prism shape, and preferably includes rounded corner portions and rounded ridgeline portions. Each corner portion is a portion where three surfaces of the multilayer body 12 cross. Each ridgeline portion is a portion where two surfaces of the multilayer body 12 cross. Protrusions and/or recesses may be provided over a portion of or the entirety of the first surface 12a, the second surface 12b, the third surface 12c, the fourth surface 12d, the fifth surface 12e, and the sixth surface 12f.

The multilayer body 12 includes a capacitance generating portion 18, a first outer layer portion 20a located closer to the first surface 12a, and a second outer layer portion 20b located closer to the second surface 12b. The first outer layer portion 20a and the second outer layer portion 20b are disposed to hold the capacitance generating portion 18 therebetween in the lamination direction x.

In the capacitance generating portion 18, the first inner electrode layers 16a and the second inner electrode layers 16b are alternately laminated with dielectric layers 14 interposed therebetween.

The first outer layer portion 20a is located closer to the first surface 12a of the multilayer body 12, and is a set of the multiple dielectric layers 14 located between the first surface 12a and a portion of the capacitance generating portion 18 nearest the first surface 12a. The second outer layer portion 20b is located closer to the second surface 12b of the multilayer body 12, and is a set of the multiple dielectric layers 14 located between the second surface 12b and a portion of the capacitance generating portion 18 nearest the second surface 12b. The area held between the first outer layer portion 20a and the second outer layer portion 20b is the capacitance generating portion 18.

The capacitance generating portion 18 is disposed in the middle in the lamination direction x. More specifically, in the lamination direction x connecting the first surface 12a and the second surface 12b, the center portion of the multilayer body 12 and the center portion of the capacitance generating portion 18 are substantially the same.

As illustrated in FIG. 7, the multilayer body 12 includes side portion areas (W gaps) 22a and 22b that are respectively located between the capacitance generating portion 18 and the fifth surface 12e and between the capacitance generating portion 18 and the sixth surface 12f, and that respectively include first extension portions 28a and second extension portions 28b of the second inner electrode layers 16b.

As illustrated in FIG. 6, the multilayer body 12 includes end portion areas (L gaps) 24a and 24b that are respectively located between the capacitance generating portion 18 and the third surface 12c and between the capacitance generating portion 18 and the fourth surface 12d, and that respectively include first extended portions 26a and second extended portions 26b of the first inner electrode layers 16a.

The dielectric layers 14 may include a ceramic material, such as a dielectric ceramic including a component such as BaTiO₃, CaTiO₃, SrTiO₃, or CaZro₃. Alternatively, a dielectric ceramic obtained by adding a secondary component such as an Mn compound, an Fe compound, a Cr compound, a Co compound, or an Ni compound to any of these main components may be used.

The thickness of each dielectric layer 14 is preferably greater than or equal to about 0.30 μm and less than or equal to about 1.00 μm, for example. Preferably, the number of the dielectric layers 14 laminated may be greater than or equal to 100 and less than or equal to 1000, for example. The number of the dielectric layers 14 is the sum of the number of the dielectric layers 14 in the capacitance generating portion 18 and the number of the dielectric layers 14 in the first outer layer portion 20a and the second outer layer portion 20b.

The inner electrode layers 16 include the first inner electrode layers 16a and the second inner electrode layers 16b.

The first inner electrode layers 16a are on the multiple dielectric layers 14. The first inner electrode layers 16a are extended to the third surface 12c and the fourth surface 12d.

More specifically, as illustrated in FIG. 8, each first inner electrode layer 16a includes a first opposing portion 25a extending between the third surface 12c and the fourth surface 12d of the multilayer body 12 and corresponding to the middle portion, a first extended portion 26a extending from the first opposing portion 25a to the third surface 12c of the multilayer body 12, and a second extended portion 26b extending from the first opposing portion 25a to the fourth surface 12d of the multilayer body 12. The first opposing portion 25a is located at the center portion of the dielectric layer 14. The first extended portion 26a is exposed to the third surface 12c of the multilayer body 12, and the second extended portion 26b is exposed to the fourth surface 12d of the multilayer body 12. Thus, the first inner electrode layers 16a are not exposed to the fifth surface 12e and the sixth surface 12f of the multilayer body 12.

Although the first inner electrode layers 16a may have any shape, the first inner electrode layers 16a preferably have a rectangular or substantially rectangular shape in a plan view. Although the first opposing portion 25a, the first extended portion 26a, and the second extended portion 26b of each first inner electrode layer 16a may have any shape, the first opposing portion 25a, the first extended portion 26a, and the second extended portion 26b preferably have a rectangular or substantially rectangular shape in a plan view. The corner portions may be rounded.

The second inner electrode layers 16b are on the multiple dielectric layers 14. The second inner electrode layers 16b are extended to the fifth surface 12e and the sixth surface 12f. The second inner electrode layers 16b are on the dielectric layers 14 different from the dielectric layers 14 on which the first inner electrode layers 16a are disposed.

More specifically, as illustrated in FIG. 9, each second inner electrode layer 16b includes a second opposing portion 25b extending between the fifth surface 12e and the sixth surface 12f of the multilayer body 12 and corresponding to the middle portion, a first extension portion 28a extending from the second opposing portion 25b to the fifth surface 12e, and a second extension portion 28b extending from the second opposing portion 25b to the sixth surface 12f. The second opposing portion 25b has a rectangular or substantially rectangular shape extending in a direction toward the third surface 12c and in a direction toward the fourth surface 12d. The second opposing portion 25b is located at the center portion of the dielectric layer 14. The first extension portion 28a is exposed to the fifth surface 12e of the multilayer body 12, and the second extension portion 28b is exposed to the sixth surface 12f of the multilayer body 12. Thus, the second inner electrode layers 16b are not exposed to the third surface 12c and the fourth surface 12d of the multilayer body 12.

The second opposing portion 25b, the first extension portion 28a, and the second extension portion 28b of each second inner electrode layer 16b may have any shape, but preferably have a rectangular or substantially rectangular shape in a plan view. The corner portions may be rounded.

The first opposing portion 25a of each first inner electrode layer 16a and the second opposing portion 25b of the corresponding second inner electrode layer 16b oppose one another. In the present example embodiment, the first opposing portion 25a of each first inner electrode layer 16a and the second opposing portion 25b of the corresponding second inner electrode layer 16b oppose with the corresponding dielectric layer 14 interposed therebetween to generate electrostatic capacitance, which gives rise to the characteristics of the capacitor.

Although the number of the first inner electrode layers 16a is not particularly limited, for example, the number is preferably greater than or equal to about 50 and less than or equal to about 500. Although the number of the second inner electrode layers 16b is not particularly limited, for example, the number of preferably greater than or equal to about 50 and less than or equal to about 500. Thus, the total number of the first inner electrode layers 16a and the second inner electrode layers 16b is preferably greater than or equal to 100 and less than or equal to 1000, for example.

Although the thickness of each of the first inner electrode layers 16a is not particularly limited, for example, the thickness is preferably greater than or equal to about 0.20 μm and less than or equal to about 0.80 μm. Although the thickness of each of the second inner electrode layers 16b is not particularly limited, for example, the thickness is preferably greater than or equal to about 0.20 μm and less than or equal to about 0.80 μm.

The first inner electrode layers 16a and the second inner electrode layers 16b may include an appropriate electroconductive material, for example, a metal such as Ni, Cu, Ag, Pd, or Au, or an alloy including any of these metals such as an Ag—Pd alloy. When an Sn layer is disposed between each first inner electrode layer 16a and the corresponding second inner electrode layer 16b and the corresponding dielectric layer 14, electric field concentration at the interface between the inner electrode layer 16 and the dielectric layer 14 can be reduced, and high-temperature load reliability is improved.

The outer electrodes 30 are provided on the third surface 12c, the fourth surface 12d, the fifth surface 12e, and the sixth surface 12f of the multilayer body 12. The outer electrodes 30 include a first outer electrode 30a, a second outer electrode 30b, a third outer electrode 30c, and a fourth outer electrode 30d.

The first outer electrode 30a is provided on the third surface 12c. The first outer electrode 30a is connected to the first inner electrode layers 16a. The first outer electrode 30a includes a first cover portion 30a1 on the third surface 12c to cover the first inner electrode layers 16a exposed to the third surface 12c, and a first turn-up portion 30a2 extending from the first cover portion 30a1 and on a portion of the first surface 12a, a portion of the second surface 12b, a portion of the fifth surface 12e, and a portion of the sixth surface 12f.

The second outer electrode 30b is provided on the fourth surface 12d. The second outer electrode 30b is connected to the first inner electrode layers 16a. The second outer electrode 30b includes a second cover portion 30b₁ on the fourth surface 12d to cover the first inner electrode layers 16a exposed to the fourth surface 12d, and a second turn-up portion 30b₂ extending from the second cover portion 30b₁ and on a portion of the first surface 12a, a portion of the second surface 12b, a portion of the fifth surface 12e, and a portion of the sixth surface 12f.

The third outer electrode 30c is provided on the fifth surface 12e. The third outer electrode 30c is connected to the second inner electrode layers 16b. The third outer electrode 30c includes a third cover portion 30c₁ covering the second inner electrode layers 16b exposed to the fifth surface 12e, and third turn-up portions 30c₂ extending from the third cover portion 30c₁ and on the first surface 12a and the second surface 12b in parallel to the second inner electrode layers 16b. The third outer electrode 30c does not necessarily have to include the third turn-up portions 30c₂.

The fourth outer electrode 30d is provided on the sixth surface 12f. The fourth outer electrode 30d is connected to the second inner electrode layers 16b. The fourth outer electrode 30d includes a fourth cover portion 30d₁ covering the second inner electrode layers 16b exposed to the sixth surface 12f, and fourth turn-up portions 30d₂ extending from the fourth cover portion 30d₁, and on the first surface 12a and the second surface 12b in parallel to the second inner electrode layers 16b. The fourth outer electrode 30d does not necessarily have to include the fourth turn-up portions 30d₂.

In the multilayer ceramic capacitor 10, the fifth surface 12e or the sixth surface 12f of the multilayer body 12 is mounted on the mount board to define and function as a board mount surface.

In the first outer electrode 30a, the first turn-up portion 30a₂ on the fifth surface 12e includes a first thickest point 30aP₁, which is a portion of the first turn-up portion 30a₂ with the largest thickness in the second direction z. The first thickest point 30aP₁ of the first turn-up portion 30a₂ on the fifth surface 12e is located at substantially the center of the first turn-up portion 30a₂.

In the first outer electrode 30a, the first turn-up portion 30a₂ on the sixth surface 12f includes a first thickest point 30aP₂, which is a portion of the first turn-up portion 30a₂ with the largest thickness in the second direction z. The first thickest point 30aP₂ of the first turn-up portion 30a₂ on the sixth surface 12f is located at substantially the center of the first turn-up portion 30a₂.

In the second outer electrode 30b, the second turn-up portion 30b₂ on the fifth surface 12e includes a second thickest point 30bP₁, which is a portion of the second turn-up portion 30b₂ with the largest thickness in the second direction z. The second thickest point 30bP₁ of the second turn-up portion 30b₂ on the fifth surface 12e is located at substantially the center of the second turn-up portion 30b₂.

In the second outer electrode 30b, the second turn-up portion 30b₂ on the sixth surface 12f includes a second thickest point 30bP₂, which is a portion of the second turn-up portion 30b₂ with the largest thickness in the second direction z. The second thickest point 30bP₂ of the second turn-up portion 30b₂ on the sixth surface 12f is located at substantially the center of the second turn-up portion 30b₂.

The third outer electrode 30c includes a third thickest point 30cP, which is a portion of the third cover portion 30c₁ of the third outer electrode 30c on the fifth surface 12e with the largest thickness in the second direction z.

The fourth outer electrode 30d includes a fourth thickest point 30dP, which is a portion of the fourth cover portion 30d₁ of the fourth outer electrode 30d on the sixth surface 12f with the largest thickness in the second direction z.

The third thickest point 30cP of the third outer electrode 30c on the fifth surface 12e is located, in the lamination direction x, closer to the first surface 12a or the second surface 12b with respect to a line m connecting the first thickest point 30aP₁ of the first turn-up portion 30a₂ on the fifth surface 12e and the second thickest point 30bP₁ of the second turn-up portion 30b₂ on the fifth surface 12e. A shortest distance d in the lamination direction x between the line m connecting the first thickest point 30aP₁ of the first turn-up portion 30a₂ on the fifth surface 12e and the second thickest point 30bP₁ of the second turn-up portion 30b₂ on the fifth surface 12e and the third thickest point 30cP of the third outer electrode 30c located closer to the first surface 12a or the second surface 12b is greater than or equal to about 50 μm, for example.

Alternatively, the fourth thickest point 30dP of the fourth outer electrode 30d on the sixth surface 12f is located, in the lamination direction x, closer to the first surface 12a or the second surface 12b with respect to a line m connecting the first thickest point 30aP₂ of the first turn-up portion 30a₂ on the sixth surface 12f and the second thickest point 30bP₂ of the second turn-up portion 30b₂ on the sixth surface 12f. The shortest distance d, in the lamination direction x, between the line m connecting the first thickest point 30aP₂ of the first turn-up portion 30a₂ on the sixth surface 12f and the second thickest point 30bP₂ of the second turn-up portion 30b₂ on the sixth surface 12f and the fourth thickest point 30dP of the fourth outer electrode 30d located closer to the first surface 12a or the second surface 12b is greater than or equal to about 50 μm, for example.

Preferably, the largest thickness of the third outer electrode 30c and the fourth outer electrode 30d in the second direction z is greater than the largest thickness of the first turn-up portion 30a₂ and the second turn-up portion 30b₂ in the second direction z.

Preferably, an average thickness of the third outer electrode 30c and the fourth outer electrode 30d in the second direction z is greater than an average thickness of the first turn-up portion 30a₂ and the second turn-up portion 30b₂ in the second direction z.

In the above structure, the third thickest point 30cP of the third outer electrode 30c, the first thickest point 30aP₁ of the first turn-up portion 30a₂ of the first outer electrode 30a, and the second thickest point 30bP₁ of the second turn-up portion 30b₂ of the second outer electrode 30b define and function as three points to be supported. Thus, when the multilayer ceramic capacitor 10 is mounted on a mount board while the fifth surface 12e defines and functions as a mount surface, the multilayer ceramic capacitor 10 can reduce inclination.

Similarly, the fourth thickest point 30dP of the fourth outer electrode 30d, the first thickest point 30aP₂ of the first turn-up portion 30a₂ of the first outer electrode 30a, and the second thickest point 30bP₂ of the second turn-up portion 30b₂ of the second outer electrode 30b define and function as three points to be supported. Thus, when the multilayer ceramic capacitor 10 is mounted on a mount board while the sixth surface 12f defines and functions as a mount surface, the multilayer ceramic capacitor 10 can reduce inclination.

The multilayer ceramic capacitor 10 includes, on the fifth surface 12e, the third thickest point 30cP of the third outer electrode 30c, the first thickest point 30aP₁ of the first turn-up portion 30a₂ of the first outer electrode 30a, and the second thickest point 30bP₁ of the second turn-up portion 30b₂ of the second outer electrode 30b, and, on the sixth surface 12f, the fourth thickest point 30dP of the fourth outer electrode 30d, the first thickest point 30aP₂ of the first turn-up portion 30a₂ of the first outer electrode 30a, and the second thickest point 30bP₂ of the second turn-up portion 30b₂ of the second outer electrode 30b. Alternatively, the multilayer ceramic capacitor 10 may include the above structure on at least one of the fifth surface 12e or the sixth surface 12f.

Each outer electrode 30 includes a base electrode layer 32 on the surface of the multilayer body 12, and a plating layer 34 disposed to cover the base electrode layer 32.

The base electrode layers 32 include a first base electrode layer 32a, a second base electrode layer 32b, a third base electrode layer 32c, and a fourth base electrode layer 32d.

The plating layers 34 include a first plating layer 34a, a second plating layer 34b, a third plating layer 34c, and a fourth plating layer 34d.

In other words, the first outer electrode 30a includes the first base electrode layer 32a and the first plating layer 34a. The second outer electrode 30b includes the second base electrode layer 32b and the second plating layer 34b. The third outer electrode 30c includes the third base electrode layer 32c and the third plating layer 34c. The fourth outer electrode 30d includes the fourth base electrode layer 32d and the fourth plating layer 34d.

The first base electrode layer 32a is provided on the third surface 12c of the multilayer body 12, and extends from over the third surface 12c to covers of the first surface 12a, the second surface 12b, the fifth surface 12e, and the sixth surface 12f.

The second base electrode layer 32b is provided on the fourth surface 12d of the multilayer body 12, and extends from over the fourth surface 12d to covers of the first surface 12a, the second surface 12b, the fifth surface 12e, and the sixth surface 12f.

The third base electrode layer 32c is provided on the fifth surface 12e of the multilayer body 12, and extends from over the fifth surface 12e to cover the second surface 12b.

The fourth base electrode layer 32d is provided on the sixth surface 12f of the multilayer body 12, and extends from over the sixth surface 12f to cover the second surface 12b.

The base electrode layer 32 includes at least one selected from the group of components including a sintered layer and an electroconductive resin layer.

Hereinbelow, structures of the base electrode layer 32 including the sintered layer and an electroconductive resin layer are described.

The sintered layer includes a glass component and a metal component. The glass component in the sintered layer includes at least one selected from the group including B, Si, Ba, Mg, Al, and Li. The metal component in the sintered layer includes at least one selected from the group including, for example, Cu, Ni, Ag, Pd, an Ag—Pd alloy, and Au. The sintered layer may include multiple layers. The sintered layer is obtained by applying an electroconductive paste including the glass component and the metal component to the multilayer body 12 and sintering the paste. The sintered layer may be obtained by concurrently sintering a multilayer chip including the inner electrode layers 16 and the dielectric layers 14 and the electroconductive paste applied to the multilayer chip, or by sintering a multilayer chip including the inner electrode layers 16 and the dielectric layers 14 to form the multilayer body 12, and then applying the electroconductive paste to the multilayer body 12 and then sintering the electroconductive paste. When the sintered layer is to be obtained by concurrently sintering a multilayer chip including the inner electrode layers 16 and the dielectric layers 14 and the electroconductive paste applied to the multilayer chip, the sintered layer is preferably formed from a material including a dielectric material instead of the glass component, and formed by sintering the material.

Preferably, the first base electrode layer 32a on the third surface 12c has a thickness greater than or equal to 6 μm and less than or equal to, for example, about 60 μm in the first direction y, connecting the third surface 12c and the fourth surface 12d at the middle portion in the lamination direction x.

Preferably, the second base electrode layer 32b on the fourth surface 12d has a thickness greater than or equal to 6 μm and less than or equal to, for example, about 60 μm in the first direction y, connecting the third surface 12c and the fourth surface 12d at the middle portion in the lamination direction x.

To dispose the first base electrode layer 32a on a portion of the first surface 12a, a portion of the second surface 12b, a portion of the fifth surface 12e, and a portion of the sixth surface 12f, a thickness of the first base electrode layer 32a on the first surface 12a and the second surface 12b, in the lamination direction x connecting the first surface 12a and the second surface 12b at the center portion in the first direction y connecting the third surface 12c and the fourth surface 12d is preferably, for example, greater than or equal to about 10 μm and less than or equal to about 50 μm. In addition, a thickness of the first base electrode layer 32a on the fifth surface 12e and the sixth surface 12f, in the second direction z connecting the fifth surface 12e and the sixth surface 12f at the center portion in the first direction y connecting the third surface 12c and the fourth surface 12d is preferably, for example, greater than or equal to 10 μm and less than or equal to about 50 μm.

To dispose the second base electrode layer 32b on a portion of the first surface 12a, a portion of the second surface 12b, a portion of the fifth surface 12e, and a portion of the sixth surface 12f, a thickness of the second base electrode layer 32b on the first surface 12a and the second surface 12b, in the lamination direction x connecting the first surface 12a and the second surface 12b at the middle portion in the first direction y connecting the third surface 12c and the fourth surface 12d is preferably, for example, greater than or equal to 10 μm and less than or equal to about 50 μm. In addition, a thickness of the second base electrode layer 32b on the fifth surface 12e and the sixth surface 12f, in the second direction z connecting the fifth surface 12e and the sixth surface 12f at the middle portion in the first direction y connecting the third surface 12c and the fourth surface 12d, is preferably, for example, greater than or equal to 10 μm and less than or equal to about 50 μm.

A thickness of the third base electrode layer 32c on the fifth surface 12e, in the second direction z connecting the fifth surface 12e and the sixth surface 12f at the middle portion in the first direction y connecting the third surface 12c and the fourth surface 12d, is preferably greater than or equal to about 10 μm and less than or equal to about 60 μm, for example.

A thickness of the fourth base electrode layer 32d on the sixth surface 12f, in the second direction z connecting the fifth surface 12e and the sixth surface 12f at the middle portion in the first direction y connecting the third surface 12c and the fourth surface 12d, is preferably greater than or equal to about 10 μm and less than or equal to about 60 μm, for example.

A thickness of the third base electrode layer 32c on the second surface 12b, in the lamination direction x connecting the first surface 12a and the second surface 12b at the middle portion in the first direction y connecting the third surface 12c and the fourth surface 12d, is preferably, for example, greater than or equal to about 5 μm and less than or equal to about 25 μm.

A thickness of the fourth base electrode layer 32d on the second surface 12b, in the lamination direction x connecting the first surface 12a and the second surface 12b at the middle portion in the first direction y connecting the third surface 12c and the fourth surface 12d, is preferably, for example, greater than or equal to about 5 μm and less than or equal to about 25 μm.

The electroconductive resin layer may be on the sintered layer to cover the sintered layer, or directly on the multilayer body 12 without providing a sintered layer. The electroconductive resin layer may cover the sintered layer completely or partially. The electroconductive resin layer may include multiple layers.

The electroconductive resin layer includes a thermosetting resin and a metal. The electroconductive resin layer includes a thermosetting resin, and is thus more flexible than a sintered layer formed from, for example, a sintered body including a plating layer and an electroconductive paste. Thus, regardless of when a physical impact or an impact attributable to a heat cycle is imposed on the multilayer ceramic capacitor 10, the multilayer ceramic capacitor 10 is prevented from being cracked with the electroconductive resin layer functioning as a buffer layer.

As a metal included in the electroconductive resin layer, Ag, Cu, Ni, Sn, or Bi or an alloy including any of these metals may be used. Alternatively, metal powder having a surface coated with Ag may be used. When metal powder having a surface coated with Ag is used, preferably, powder of Cu, Ni, Sn, or Bi or an alloy including any of these metals is preferably used as metal powder. The reason why electroconductive metal powder of Ag is used as the electroconductive metal is because Ag has the lowest resistivity among metals, and is thus suitable as an electrode material, and Ag is a noble metal and not oxidizable, and thus has high weather resistance. In addition, use of Ag as electroconductive metal powder enables use of a low-cost metal as a base material while the characteristics of Ag are maintained.

Alternatively, as a metal included in the electroconductive resin layer, Cu or Ni that has undergone anti-oxidation processing may be used. As a metal included in the electroconductive resin layer, metal powder with a surface coated with Sn, Ni, or Cu may be used. When metal powder with a surface coated with Sn, Ni, or Cu is used, preferably, the metal powder may include powder of Ag, Cu, Ni, Sn, or Bi or an alloy of any of these.

The metal included in the electroconductive resin layer is mainly used for current-carrying performance in the electroconductive resin layer. More specifically, with the contact between electroconductive fillers, current-carrying paths are formed in the electroconductive resin layer.

The metal included in the electroconductive resin layer may be, for example, globular or flat, but preferably has a mixture of globular metal powder and flat metal powder.

Examples of resins in the electroconductive resin layer include various known thermosetting resins such as an epoxy resin, a phenolic resin, a polyurethane resin, a silicone resin, and a polyimide resin. Among these, an epoxy resin is one of the most appropriate resins, because of its high thermal resistance, high moisture resistance, and strong adhesion.

Preferably, the electroconductive resin layer includes a curing agent together with a thermosetting resin. When an epoxy resin is used as a base resin, any of various known compounds such as phenolic, aminic, acid anhydride, imidazole, active ester, and amide-imide compounds may be used as a curing agent.

A thickest portion of the electroconductive resin layer may preferably have a thickness of, for example, greater than or equal to about 10 μm and less than or equal to about 50 μm.

The plating layer 34 is disposed to cover the base electrode layer 32.

The plating layer 34 includes at least one selected from the group including, for example, Cu, Ni, Sn, Ag, Pd, an Ag—Pd alloy, and Au.

The plating layer 34 may include multiple layers. In this case, the plating layer 34 preferably has a two-layer structure including an Ni plating layer and an Sn plating layer. The Ni plating layer is used to prevent the base electrode layer 32 from being corroded by solder used to mount the multilayer ceramic capacitor 10. The Sn plating layer is used to improve solder wettability to mount the multilayer ceramic capacitor 10, and to facilitate the mounting. Each layer in the plating layer 34 preferably has a thickness of greater than or equal to about 1 μm and less than or equal to about 10 μm, for example.

The dimension of the multilayer ceramic capacitor 10 including the multilayer body 12 and the outer electrodes 30 in the first direction y is defined as an L dimension. The L dimension is preferably greater than or equal to about 0.10 mm and less than or equal to about 3.50 mm, or more preferably, greater than or equal to about 0.40 mm and less than or equal to about 2.20 mm, for example.

The dimension of the multilayer ceramic capacitor 10 including the multilayer body 12 and the outer electrodes 30 in the second direction z is defined as a T dimension. The T dimension is preferably greater than or equal to about 0.07 mm and less than or equal to about 3.00 mm, or more preferably, greater than or equal to about 0.25 mm and less than or equal to about 1.50 mm, for example.

The dimension of the multilayer ceramic capacitor 10 including the multilayer body 12 and the outer electrodes 30 in the lamination direction x is defined as a W dimension. The W dimension is preferably greater than or equal to about 0.05 mm and less than or equal to about 2.80 mm, or more preferably, greater than or equal to about 0.20 mm and less than or equal to about 1.45 mm, for example.

In the multilayer ceramic capacitor 10, the W dimension, or a dimension in the lamination direction x, is smaller than the T dimension in the second direction z.

In the multilayer ceramic capacitor 10 illustrated in FIG. 1, the third thickest point 30cP of the third outer electrode 30c on the fifth surface 12e is located closer to the first surface 12a or the second surface 12b in the lamination direction x, with respect to the line m connecting the first thickest point 30aP₁ of the first turn-up portion 30a₂ on the fifth surface 12e and the second thickest point 30bP₁ of the second turn-up portion 30b₂ on the fifth surface 12e. The shortest distance d in the lamination direction x between the line m connecting the first thickest point 30aP₁ of the first turn-up portion 30a₂ on the fifth surface 12e and the second thickest point 30bP₁ of the second turn-up portion 30b₂ on the fifth surface 12e and the third thickest point 30cP of the third outer electrode 30c located closer to the first surface 12a or the second surface 12b is greater than or equal to about 50 μm, for example. Thus, when the fifth surface 12e defines and functions as the mount surface and the thickest points define and function as the three points to be supported to mount the multilayer ceramic capacitor 10 on a mount board, the multilayer ceramic capacitor 10 reduces inclination and can thus be stably mounted while remaining nearly untilted.

Similarly, in the multilayer ceramic capacitor 10 illustrated in FIG. 1, the fourth thickest point 30dP of the fourth outer electrode 30d on the sixth surface 12f is located closer to the first surface 12a or the second surface 12b in the lamination direction x, with respect to the line m connecting the first thickest point 30aP₂ of the first turn-up portion 30a₂ on the sixth surface 12f and the second thickest point 30bP₂ of the second turn-up portion 30b₂ on the sixth surface 12f. The shortest distance d between the line m connecting the first thickest point 30aP₂ of the first turn-up portion 30a₂ on the sixth surface 12f and the second thickest point 30bP₂ of the second turn-up portion 30b₂ on the sixth surface 12f and the fourth thickest point 30dP of the fourth outer electrode 30d on the first surface 12a or the second surface 12b in the lamination direction x is greater than or equal to about 50 μm. Thus, when the sixth surface 12f defines and functions as the mount surface and the thickest points define and function as the three points to be supported to mount the multilayer ceramic capacitor 10 on a mount board, the multilayer ceramic capacitor 10 reduces inclination and can thus be stably mounted while remaining nearly untilted.

A non-limiting example of a method for manufacturing the multilayer ceramic capacitor 10 according to an example embodiment of the present invention is described now.

A dielectric sheet for the dielectric layers and an electroconductive paste for the inner electrode layers are prepared first. The dielectric sheet and the electroconductive paste for the inner electrode layers include a binder and a solvent. A known binder and a known solvent may be used as the binder and the solvent.

The electroconductive paste for the inner electrode layers is applied onto the dielectric sheet in a predetermined pattern by, for example, screen printing or photogravure. Thus, dielectric sheets on each of which the pattern of the first inner electrode layer is formed, and dielectric sheets on each of which the pattern of the second inner electrode layer is formed are prepared.

More specifically, a photogravure printing plate for printing the first inner electrode layers and the second inner electrode layers are prepared to print the inner electrode layers of the present invention.

Subsequently, a predetermined number of dielectric sheets on each of which the pattern of the inner electrode layer is not printed are laminated, and a portion forming the second outer layer portion 20b located closer to the second surface 12b is formed. Thereafter, on the portion forming the second outer layer portion 20b, sheets on each of which the first inner electrode layer is printed and sheets on each of which the second inner electrode layer is printed are alternately laminated to form the capacitance generating portion 18. The portion formed in the above process to form the capacitance generating portion 18 is laminated on the portion that forms the second outer layer portion 20b. A predetermined number of dielectric sheets on each of which the pattern of the inner electrode layer is not printed are then laminated on the portion that forms the capacitance generating portion 18, and thus the portion forming the first outer layer portion 20a located closer to the first surface 12a is formed. Thus, a multilayer sheet is manufactured.

Subsequently, the multilayer sheet is pressed in the lamination direction by, for example, isostatic pressing to fabricate a multilayer block.

The multilayer block is then cut into multilayer chips of a predetermined size. At this time, the corner portions and the ridgeline portions of the multilayer chips may be rounded by, for example, barrel finishing.

Each cut multilayer chip is then sintered to be formed into a multilayer body 12. Although depending on the material of the dielectric layers 14 or the inner electrode layers 16, the sintering temperature is preferably greater than or equal to about 900° C. and less than or equal to about 1400° C., for example.

Subsequently, the third base electrode layer 32c of the third outer electrode 30c is formed on the fifth surface 12e of the multilayer body 12 obtained by sintering, and the fourth base electrode layer 32d of the fourth outer electrode 30d is formed on the sixth surface 12f of the multilayer body 12.

An electroconductive paste including a glass component and a metal component is applied, and then sintered to form a sintered layer serving as the base electrode layer 32. The temperature of the sintering process is preferably greater than or equal to about 700° C. and less than or equal to about 900° C., for example. In the present example embodiment, each base electrode layer 32 includes a sintered layer.

The sintered layers may be formed by various methods. For example, the sintered layers may be formed by a roller transfer method. To form, with the roller transfer method, the base electrode layer 132 on, not only the fifth surface 12e and the sixth surface 12f, but also on a portion of the first surface 12a and a portion of the second surface 12b, the exerted pressure and the roller speed in roller transfer are adjusted to form the third thickest point and the fourth thickest point respectively on the fifth surface 12e and the sixth surface 12f while the locations of the third thickest point and the fourth thickest point are adjusted. Exerting a higher pressure in roller transfer enables forming the base electrode layer 132 on a portion of the first surface 12a and a portion of the second surface 12b.

Subsequently, the first base electrode layer 32a of the first outer electrode 30a is formed on the third surface 12c of the multilayer body 12 obtained by sintering, and the second base electrode layer 32b of the second outer electrode 30b is formed on the fourth surface 12d of the multilayer body 12. In the present example embodiment, the first base electrode layer 32a and the second base electrode layer 32b are formed by a dual in-line package (DIP) method to extend to cover a portion of the first surface 12a, a portion of the second surface 12b, a portion of the fifth surface 12e, and a portion of the sixth surface 12f, not only to cover the third surface 12c and the fourth surface 12d.

In the sintering process, the first base electrode layer 32a of the first outer electrode 30a, the second base electrode layer 32b of the second outer electrode 30b, the third base electrode layer 32c of the third outer electrode 30c, and the fourth base electrode layer 32d of the fourth outer electrode 30d may be concurrently sintered, or a set of the first base electrode layer 32a of the first outer electrode 30a and the second base electrode layer 32b of the second outer electrode 30b and a set of the third base electrode layer 32c of the third outer electrode 30c and the fourth base electrode layer 32d of the fourth outer electrode 30d may be separately sintered.

To form each base electrode layer 32 from an electroconductive resin layer, the electroconductive resin layer can be formed by the method below. The electroconductive resin layer may be formed on the surface of the sintered layer, or may be simply and directly formed on the multilayer body 12 without the sintered layer interposed therebetween.

The method for forming an electroconductive resin layer includes applying an electroconductive resin paste including a thermosetting resin and a metal component to the sintered layer or the multilayer body 12, thermally processing the electroconductive resin paste at a temperature greater than or equal to about 250° C. and less than or equal to about 550° C., and thermally curing the resin to form the electroconductive resin layer. An N2 atmosphere is preferable as the atmosphere during the thermal processing. In addition, to prevent scattering of the resin and oxidation of each metal component, preferably, the oxygen content is less than or equal to about 100 ppm, for example.

As in the method for forming the base electrode layer 32 from a sintered layer, the electroconductive resin paste may be applied by, for example, squeezing an electroconductive resin paste out of a slit.

Finally, the plating layer 34 is formed. The plating layer 34 may be formed on the surface of the base electrode layer 32, or directly on the multilayer body 12. In the present example embodiment, the plating layer 34 is formed on the surface of the base electrode layer 32. More specifically, on the base electrode layer 32, an Ni plating layer is formed as a lower plating layer and an Sn plating layer is formed as an upper plating layer. The plating processing may be either electrolytic plating for electroless plating. However, electroless plating involves preprocessing using, for example, a catalyst to improve the plating deposition speed, and complicates the processing. Thus, using electrolytic plating is normally preferable.

The multilayer ceramic capacitor 10 according to the first example embodiment is preferably manufactured in the above manner.

An example of a multilayer ceramic capacitor 110 according to a second example embodiment of the present invention is described.

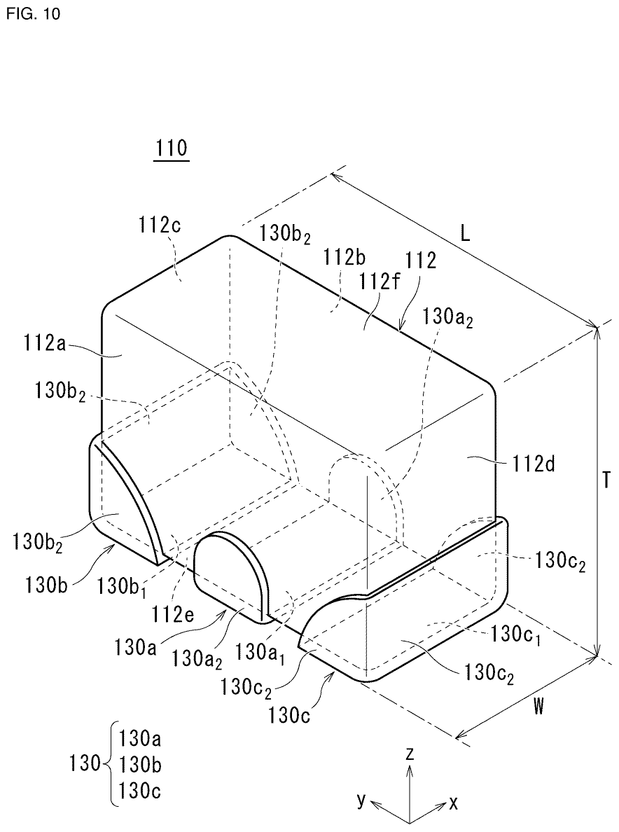

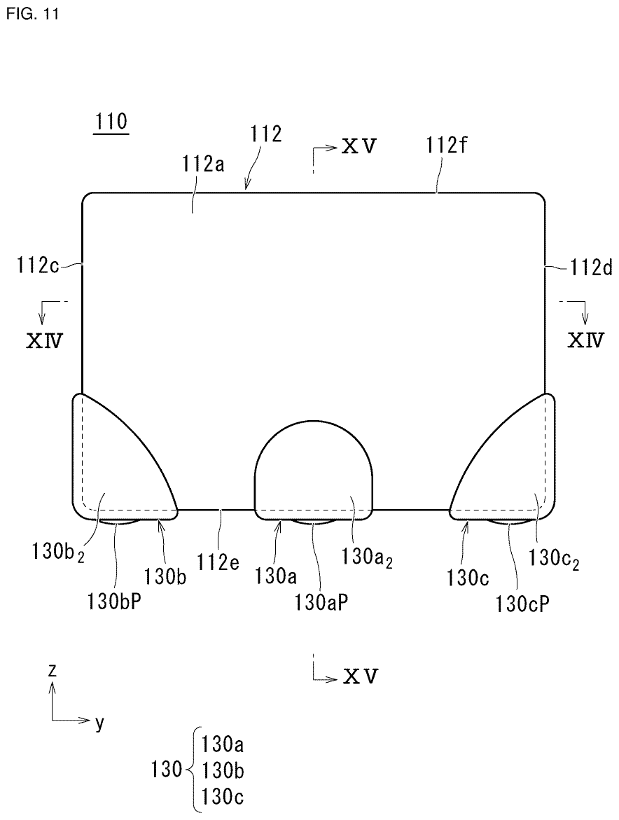

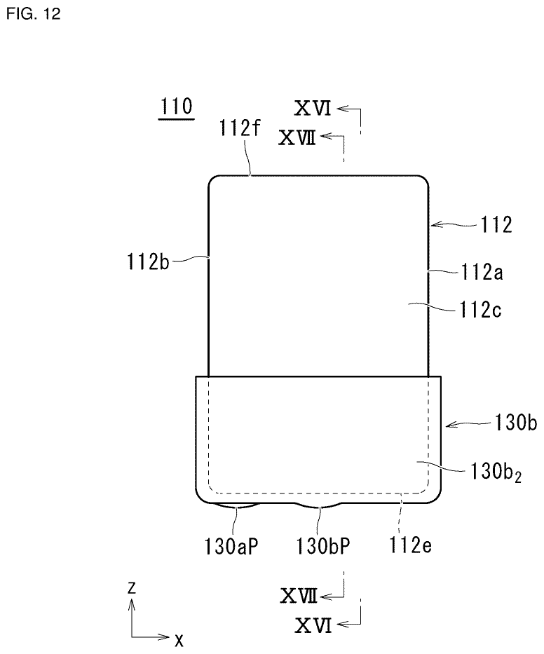

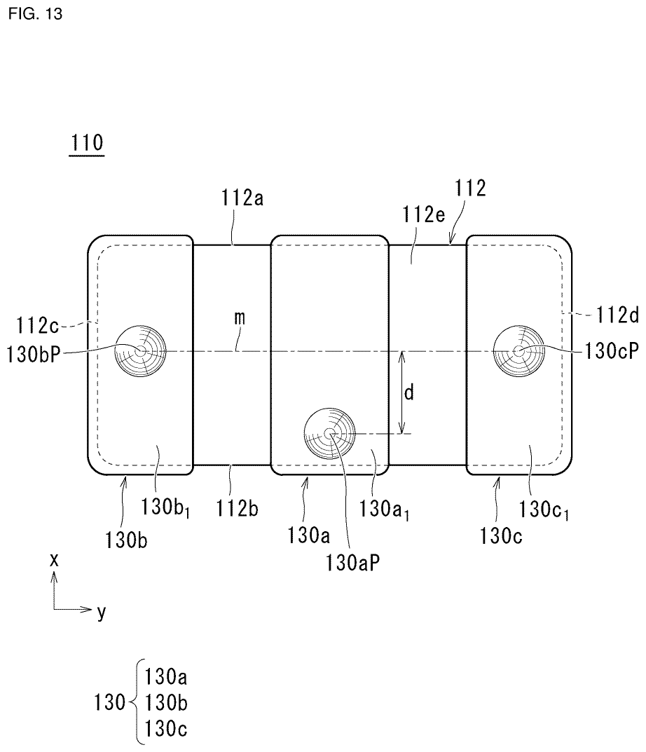

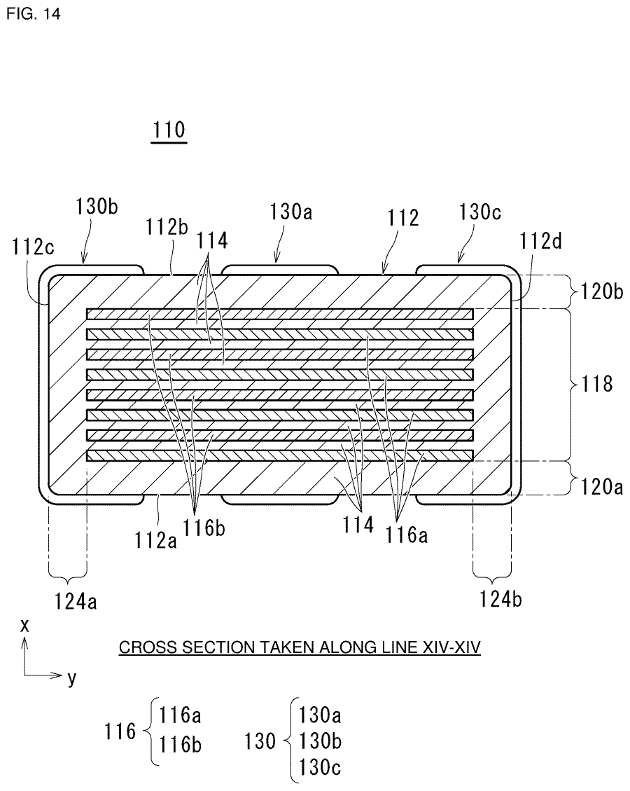

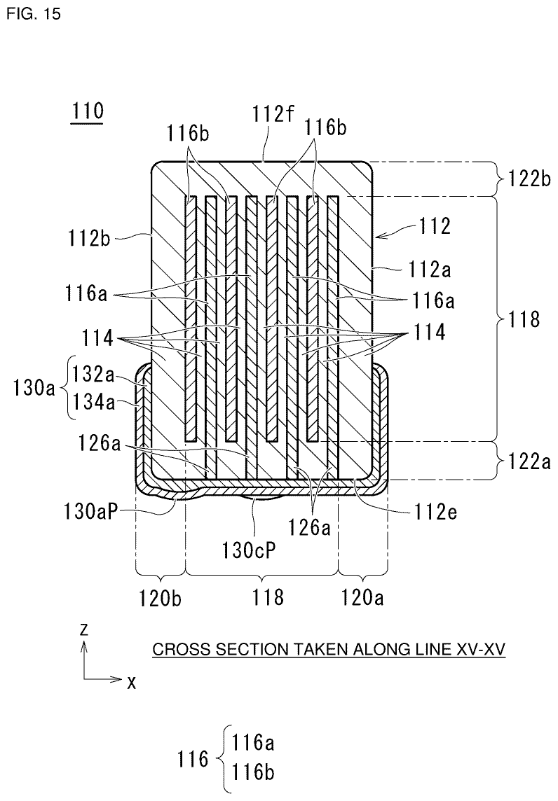

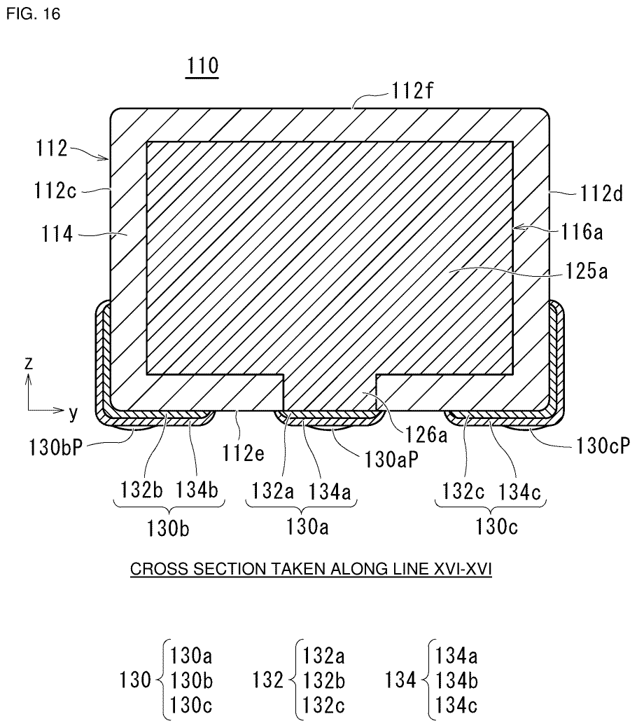

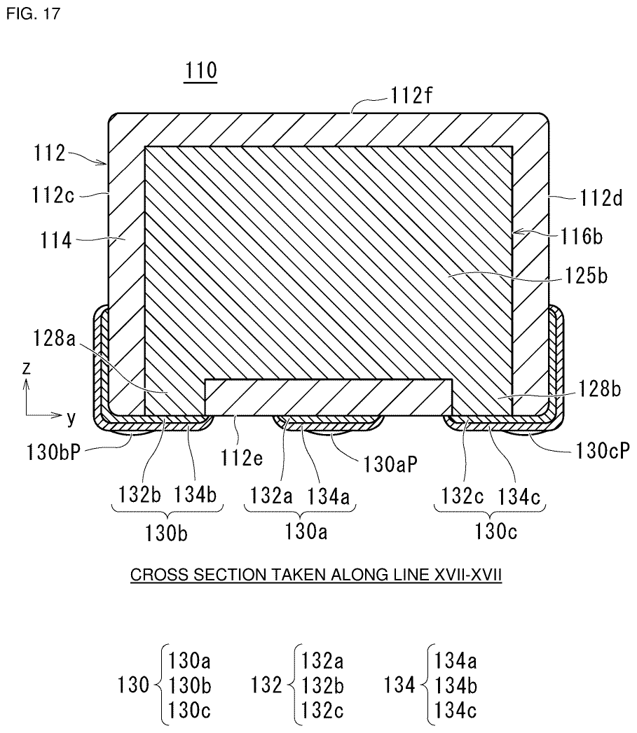

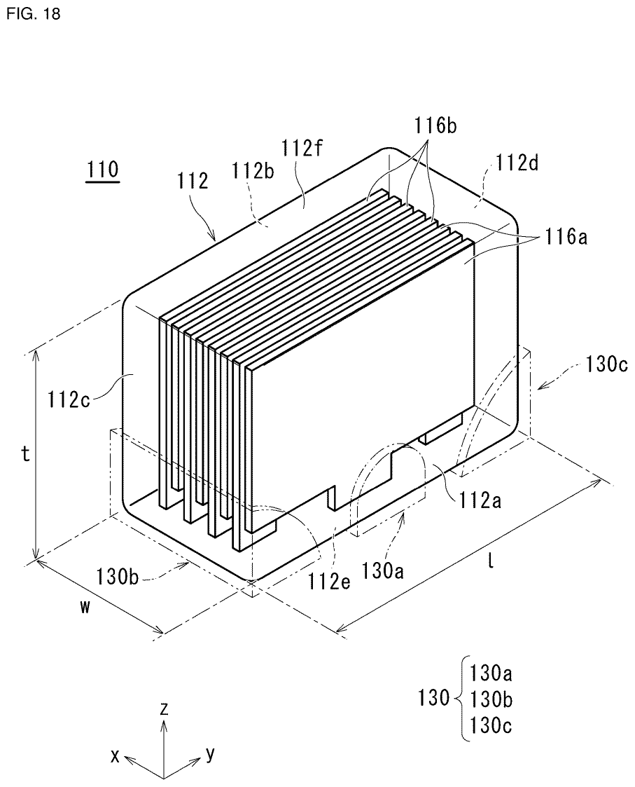

FIG. 10 is an external perspective view of a multilayer ceramic capacitor according to a second example embodiment of the present invention. FIG. 11 is a right side view of an example of the multilayer ceramic capacitor according to the second example embodiment of the present invention. FIG. 12 is a front view of an example of the multilayer ceramic capacitor according to the second example embodiment of the present invention. FIG. 13 is a bottom view of an example of the multilayer ceramic capacitor according to the second example embodiment of the present invention. FIG. 14 is a schematic cross-sectional view of the multilayer ceramic capacitor taken along line XIV-XIV in FIG. 11. FIG. 15 is a schematic cross-sectional view of the multilayer ceramic capacitor taken along line XV-XV in FIG. 11. FIG. 16 is a schematic cross-sectional view of the multilayer ceramic capacitor taken along line XVI-XVI in FIG. 12. FIG. 17 is a schematic cross-sectional view of the multilayer ceramic capacitor taken along line XVII-XVII in FIG. 12. FIG. 18 is a perspective view of an inner electrode layer disposed in a multilayer body of the multilayer ceramic capacitor according to the second example embodiment of the present invention.

As illustrated in FIG. 10 to FIG. 17, the multilayer ceramic capacitor 110 includes, for example, a multilayer body 112 and outer electrodes 130.

The multilayer body 112 includes multiple laminated dielectric layers 114, and multiple inner electrode layers 116 laminated on the dielectric layers 114. The inner electrode layers 116 include first inner electrode layers 116a and second inner electrode layers 116b. The first inner electrode layers 116a and the second inner electrode layers 116b are described later in detail.

The multilayer body 112 includes a first surface 112a and a second surface 112b opposing in the lamination direction x, a third surface 112c and a fourth surface 112d opposing in the first direction y orthogonal to the lamination direction x, and a fifth surface 112e and a sixth surface 112f opposing in the second direction z orthogonal to the lamination direction x and the first direction y.

Preferably, the multilayer body 112 has a rectangular or substantially rectangular prism shape, and has rounded corner portions and rounded ridgeline portions. Each corner portion is a portion where three surfaces of the multilayer body 112 cross. Each ridgeline portion is a portion where two surfaces of the multilayer body 112 cross. Protrusions and/or recesses may be provided over a portion of or the entirety of the first surface 112a, the second surface 112b, the third surface 112c, the fourth surface 112d, the fifth surface 112e, and the sixth surface 112f.

The multilayer body 112 includes a capacitance generating portion 118, a first outer layer portion 120a located closer to the first surface 112a, and a second outer layer portion 120b located closer to the second surface 112b. The first outer layer portion 120a and the second outer layer portion 120b are disposed to hold the capacitance generating portion 118 therebetween in the lamination direction x.

In the capacitance generating portion 118, the first inner electrode layers 116a and the second inner electrode layers 116b are alternately laminated with dielectric layers 114 interposed therebetween.

The first outer layer portion 120a is located closer to the first surface 112a of the multilayer body 112, and is a set of the multiple dielectric layers 114 located between the first surface 112a and a portion of the capacitance generating portion 118 nearest the first surface 112a. The second outer layer portion 120b is located closer to the second surface 112b of the multilayer body 112, and is a set of the multiple dielectric layers 114 located between the second surface 112b and a portion of the capacitance generating portion 118 nearest the second surface 112b. The area held between the first outer layer portion 120a and the second outer layer portion 120b is the capacitance generating portion 118.

As illustrated in FIG. 15, the multilayer body 112 includes a side portion area 122a that is located between the capacitance generating portion 118 and the fifth surface 112e, and that includes first extended portions 126a of the first inner electrode layers 116a and second extended portions 128a and third extended portions 128b of the second inner electrode layers 16b, and a side portion area 122b located between the capacitance generating portion 118 and the sixth surface 112f.

As illustrated in FIG. 14, the multilayer body 112 includes end portion areas 124a and 124b respectively located between the capacitance generating portion 118 and the third surface 112c and between the capacitance generating portion 118 and the fourth surface 112d.

The dielectric layers 114 may include a ceramic material, such as a dielectric ceramic including a component such as BaTio₃, CaTiO₃, SrTiO₃, or CaZro₃. Alternatively, a dielectric ceramic obtained by adding a secondary component such as an Mn compound, an Fe compound, a Cr compound, a Co compound, or an Ni compound to any of these main components may be used.

The thickness of each dielectric layer 114 is preferably greater than or equal to about 0.30 μm and less than or equal to about 1.00 μm, for example. Preferably, the number the dielectric layers 114 laminated may be greater than or equal to 100 and less than or equal to 1000, for example. The number of the dielectric layers 114 is the sum of the number of the dielectric layers 114 in the capacitance generating portion 118 and the number of the dielectric layers 114 in the first outer layer portion 120a and the second outer layer portion 120b.

The inner electrode layers 116 include first inner electrode layers 116a and second inner electrode layers 116b.

The first inner electrode layers 116a are on the multiple dielectric layers 114. The first inner electrode layers 116a are extended to the fifth surface 112e.

More specifically, as illustrated in FIG. 16, each first inner electrode layer 116a includes a first opposing portion 125a opposing the corresponding second inner electrode layer 116b, and a first extended portion 126a extending from the first opposing portion 125a to the fifth surface 112e. The first opposing portion 125a is located at the middle portion of the corresponding dielectric layer 114. The first extended portion 126a is exposed to the fifth surface 112e of the multilayer body 112. Thus, the first inner electrode layers 116a are not exposed to the third surface 112c, the fourth surface 112d, and the sixth surface 112f of the multilayer body 112. Although the first opposing portion 125a and the first extended portion 126a may have any shape, the first opposing portion 125a and the first extended portion 126a preferably have a rectangular or substantially rectangular shape. The corner portions of the first opposing portion 125a may be rounded.

As illustrated in FIG. 17, each second inner electrode layer 116b includes a second opposing portion 125b opposing the corresponding first inner electrode layer 116a, and the second extended portion 128a and the third extended portion 128b extending from a second opposing portion 126b to the fifth surface 112e. The second opposing portion 125b is provided on the center portion of the corresponding dielectric layer 114. The second extended portion 128a is exposed to the fifth surface 112e at a position closer to the third surface 112c. The third extended portion 128b is exposed to the fifth surface 112e at a position closer to the fourth surface 112d. The second inner electrode layers 116b are thus not exposed to the third surface 112c, the fourth surface 112d, and the sixth surface 112f of the multilayer body 112. The second opposing portion 125b, the second extended portion 128a, and the third extended portion 128b may have any shape, but preferably have a rectangular or substantially rectangular shape. The corner portions of the second opposing portion 125b may be rounded.

The first opposing portion 125a of each first inner electrode layer 116a and the second opposing portion 125b of the corresponding second inner electrode layer 116b oppose one another. In the present example embodiment, the first opposing portion 125a of each first inner electrode layer 116a and the second opposing portion 125b of the corresponding second inner electrode layer 116b oppose with the corresponding dielectric layer 114 interposed therebetween to form electrostatic capacitance, which gives rise to the characteristics of the capacitor.

Although not particularly limited, the number of the first inner electrode layers 116a is, for example, preferably greater than or equal to about 50 and less than or equal to about 500. Although not particularly limited, the number of the second inner electrode layers 116b is, for example, preferably greater than or equal to about 50 and less than or equal to about 500. Thus, the total number of the first inner electrode layers 116a and the second inner electrode layers 116b is preferably greater than or equal to 100 and less than or equal to 1000, for example.

Although not particularly limited, the thickness of each of the first inner electrode layers 116a is, for example, preferably greater than or equal to about 0.20 μm and less than or equal to about 0.80 μm. Although not particularly limited, the thickness of each of the second inner electrode layers 116b is, for example, preferably greater than or equal to about 0.20 μm and less than or equal to about 0.80 μm.

The first inner electrode layers 116a and the second inner electrode layers 116b may include an appropriate electroconductive material, for example, a metal such as Ni, Cu, Ag, Pd, or Au, or an alloy including any of these metals such as an Ag—Pd alloy.

When an Sn layer is disposed between each of the first inner electrode layers 116a and the second inner electrode layers 116b and the corresponding dielectric layer 114, electric field concentration at the interface between the inner electrode layer 116 and the dielectric layer 114 can be reduced, and high-temperature load reliability is improved.

The outer electrodes 130 include a first outer electrode 130a, a second outer electrode 130b, and a third outer electrode 130c.

The first outer electrode 130a is provided on the fifth surface 112e. The first outer electrode 130a is connected to the first extended portions 126a of the first inner electrode layers 116a. The first outer electrode 130a may include a first cover portion 130a₁ that covers the first extended portions 126a of the first inner electrode layers 116a exposed to the fifth surface 112e, and first turn-up portions 130az extending from the first cover portion 130a₁ and on the first surface 112a and the second surface 112b in parallel to the first inner electrode layers 116a.

The second outer electrode 130b is provided on the fifth surface 112e. The second outer electrode 130b is connected to the second extended portions 128a of the second inner electrode layers 116b. The second outer electrode 130b includes a second cover portion 130b₁ that covers the second extended portions 128a of the second inner electrode layers 116b exposed to the fifth surface 112e, and a second turn-up portion 130b₂ extending from the second cover portion 130b₁ and on a portion of the first surface 112a, a portion of the second surface 112b, and a portion of the third surface 112c.

The third outer electrode 130c is provided on the fifth surface 112e. The third outer electrode 130c is connected to the third extended portions 128b of the second inner electrode layers 116b. The third outer electrode 130c includes a third cover portion 130c₁ that covers the third extended portions 128b of the second inner electrode layers 116b exposed to the fifth surface 112e, and a third turn-up portion 130c₂ extending from the third cover portion 130c₁ and on a portion of the first surface 112a, a portion of the second surface 112b, and a portion of the fourth surface 112d.

In the multilayer ceramic capacitor 110, the fifth surface 112e of the multilayer body 112 is provided on the mount board to define and function as a board mount surface.

The first outer electrode 130a includes a first thickest point 130aP, which is a portion of the first outer electrode 130a on the fifth surface 112e and having the largest thickness in the second direction z.

The second outer electrode 130b includes a second thickest point 130bP, which is a portion of the second outer electrode 130b on the fifth surface 112e and having the largest thickness in the second direction z.

The third outer electrode 130c includes a third thickest point 130cP, which is a portion of the third outer electrode 130c on the fifth surface 112e and having the largest thickness in the second direction z.

The first thickest point 130aP of the first outer electrode 130a is located, in the lamination direction x, closer to the first surface 112a or the second surface 112b with respect to a line m connecting the second thickest point 130bP of the second outer electrode 130b and the third thickest point 130cP of the third outer electrode 130c. A shortest distance d in the lamination direction x between the line m connecting the second thickest point 130bP of the second outer electrode 130b and the third thickest point 130cP of the third outer electrode 130c and the first thickest point 130aP of the first outer electrode 130a located closer to the first surface 112a or the second surface 112b is greater than or equal to about 50 μm, for example.

The second thickest point 130bP of the second outer electrode 130b is located at substantially the middle portion of the second outer electrode 130b on the fifth surface 112e.

The third thickest point 130cP the third outer electrode 130c is located at substantially the middle portion of the third outer electrode 130c on the fifth surface 112e.

Preferably, the largest thickness of the first outer electrode 130a in the second direction z is greater than the largest thickness of the second outer electrode 130b and the third outer electrode 130c in the second direction z.

Preferably, an average thickness of the first outer electrode 130a in the second direction z is greater than an average thickness of the second outer electrode 130b and the third outer electrode 130c in the second direction z.

Each outer electrode 130 includes a base electrode layer 132 on the surface of the multilayer body 112, and a plating layer 134 disposed to cover the base electrode layer 132.

The base electrode layers 132 include a first base electrode layer 132a, a second base electrode layer 132b, and a third base electrode layer 132c.

The plating layers 134 include a first plating layer 134a, a second plating layer 134b, and a third plating layer—134c.

In other words, the first outer electrode 130a includes the first base electrode layer 132a and the first plating layer 134a. The second outer electrode 130b includes the second base electrode layer 132b and the second plating layer 134b. The third outer electrode 130c includes the third base electrode layer 132c and the third plating layer 134c.

The first base electrode layer 132a is provided on the fifth surface 112e of the multilayer body 112, and extends from over the fifth surface 112e to covers of the first surface 112a and the second surface 112b.

The second base electrode layer 132b is provided on the fifth surface 112e of the multilayer body 112, and extends from over the fifth surface 112e to covers of the first surface 112a, the second surface 112b, and the third surface 112c.

The third base electrode layer 132c is provided on the fifth surface 112e of the multilayer body 112, and extends from over the fifth surface 112e to covers of the first surface 112a, the second surface 112b, and the fourth surface 112d.

The base electrode layers 132 include at least one selected from the group of components including a sintered layer and an electroconductive resin layer.

Hereinbelow, structures of the base electrode layer 132 including the sintered layer and an electroconductive resin layer are described.

The sintered layer includes a glass component and a metal component. The glass component in the sintered layer includes at least one selected from the group including B, Si, Ba, Mg, Al, and Li. The metal component in the sintered layer includes at least one selected from the group including, for example, Cu, Ni, Ag, Pd, an Ag—Pd alloy, and Au. The sintered layer may include multiple layers. The sintered layer is obtained by applying an electroconductive paste including the glass component and the metal component to the multilayer body 112 and sintering the paste.

The sintered layer may be obtained by concurrently sintering a multilayer chip including the inner electrode layers 116 and the dielectric layers 114 and the electroconductive paste applied to the multilayer chip, or by sintering a multilayer chip including the inner electrode layers 116 and the dielectric layers 114 to form the multilayer body 112, and then applying the electroconductive paste to the multilayer body 112 and then sintering the electroconductive paste. When the sintered layer is to be obtained by concurrently sintering a multilayer chip including the inner electrode layers 116 and the dielectric layers 114 and the electroconductive paste applied to the multilayer chip, the sintered layer is preferably formed from a material including a dielectric material instead of the glass component, and formed by sintering the material.

Preferably, the first base electrode layer 132a located on the fifth surface 112e and extending in the lamination direction x at the middle portion in the first direction y connecting the third surface 112c and the fourth surface 112d has a thickness in the second direction z connecting the fifth surface 112e and the sixth surface 112f approximately greater than or equal to about 10 μm and less than or equal to about 60 μm, for example.

Preferably, the second base electrode layer 132b located on the fifth surface 112e and extending in the lamination direction x at a first end portion in the first direction y connecting the third surface 112c and the fourth surface 112d has a thickness in the second direction z connecting the fifth surface 112e and the sixth surface 112f approximately greater than or equal to about 10 μm and less than or equal to about 60 μm, for example.

Preferably, the third base electrode layer 132c located on the fifth surface 112e and extending in the lamination direction x at a second end portion in the first direction y connecting the third surface 112c and the fourth surface 112d has a thickness in the second direction z connecting the fifth surface 112e and the sixth surface 112f approximately greater than or equal to 10 μm and less than or equal to about 60 μm, for example.

Preferably, the first base electrode layers 132a of the first turn-up portions 130a₂ located on a portion of the first surface 112a and a portion of the second surface 112b have a thickness, for example, approximately greater than or equal to about 3 μm and less than or equal to about 10 μm in the lamination direction x connecting the first surface 112a and the second surface 112b at a middle portion in the first direction y connecting the third surface 112c and the fourth surface 112d.

Preferably, the second base electrode layer 132b of the second turn-up portion 130b₂ located on a portion of the first surface 112a and a portion of the second surface 112b has a thickness, for example, approximately greater than or equal to about 3 μm and less than or equal to about 10 μm in the lamination direction x connecting the first surface 112a and the second surface 112b at a middle portion in the first direction Y connecting the third surface 112c and the fourth surface 112d.

Preferably, the third base electrode layer 132c of the third turn-up portion 130c₂ located on a portion of the first surface 112a and a portion of the second surface 112b has a thickness, for example, approximately greater than or equal to about 3 μm and less than or equal to about 10 μm in the lamination direction x connecting the first surface 112a and the second surface 112b at a middle portion in the first direction y connecting the third surface 112c and the fourth surface 112d.

The electroconductive resin layer may be on the sintered layer to cover the sintered layer, or directly on the multilayer body 112 without providing a sintered layer. The electroconductive resin layer may cover the sintered layer completely or partially. The electroconductive resin layer may include multiple layers.

The electroconductive resin layer includes a thermosetting resin and a metal. The electroconductive resin layer includes a thermosetting resin, and is thus more flexible than a sintered layer formed from, for example, a sintered body including a plating layer and an electroconductive paste. Thus, regardless of when a physical impact or an impact attributable to a heat cycle is imposed on the multilayer ceramic capacitor 110, the multilayer ceramic capacitor 110 is prevented from being cracked with the electroconductive resin layer functioning as a buffer layer.

As a metal included in the electroconductive resin layer, Ag, Cu, Ni, Sn, or Bi or an alloy including any of these metals may be used. Alternatively, metal powder having a surface coated with Ag may be used. When metal powder having a surface coated with Ag is used, preferably, powder of Cu, Ni, Sn, or Bi or an alloy including any of these metals is preferably used as metal powder. The reason why electroconductive metal powder of Ag is used as the electroconductive metal is because Ag has the lowest resistivity among metals, and is thus suitable as an electrode material, and Ag is a noble metal and not oxidized, and thus has high weather resistance. In addition, use of Ag as electroconductive metal powder enables use of a low-cost metal as a base material while the characteristics of Ag are maintained.

Alternatively, as a metal included in the electroconductive resin layer, Cu or Ni that has undergone anti-oxidation processing may be used. As a metal included in the electroconductive resin layer, metal powder with a surface coated with Sn, Ni, or Cu may be used. When metal powder with a surface coated with Sn, Ni, or Cu is used, preferably, the metal powder may include powder of Ag, Cu, Ni, Sn, or Bi or an alloy of any of these.

The metal included in the electroconductive resin layer is mainly used for current-carrying performance in the electroconductive resin layer. More specifically, with the contact between electroconductive fillers, current-carrying paths are formed in the electroconductive resin layer.

The metal included in the electroconductive resin layer may, for example, globular or flat, but preferably includes a mixture of globular metal powder and flat metal powder.

Examples of resins in the electroconductive resin layer include various known thermosetting resins such as an epoxy resin, a phenolic resin, a polyurethane resin, a silicone resin, and a polyimide resin. Among these, an epoxy resin is one of the most appropriate resins, because of its high thermal resistance, high moisture resistance, and strong adhesion.

Preferably, the electroconductive resin layer includes a curing agent together with a thermosetting resin. When an epoxy resin is used as a base resin, any of various known compounds such as phenolic, aminic, acid anhydride, imidazole, active ester, and amide-imide compounds may be used as a curing agent of the epoxy resin.

Preferably, a thickest portion of the electroconductive resin layer has a thickness of, for example, greater than or equal to about 10 μm and less than or equal to 60 μm.

The plating layer 134 is disposed to cover the base electrode layer 132.

The plating layer 134 includes at least one selected from the group including, for example, Cu, Ni, Sn, Ag, Pd, an Ag—Pd alloy, and Au.

The plating layer 134 may include multiple layers. In this case, the plating layer 134 preferably has a two-layer structure including an Ni plating layer and an Sn plating layer. The Ni plating layer is used to prevent the base electrode layer 132 from being corroded by solder used to mount the multilayer ceramic capacitor 110. The Sn plating layer is used to improve solder wettability to mount the multilayer ceramic capacitor 110, and to facilitate the mounting. Each layer in the plating layer 134 preferably has a thickness of greater than or equal to about 1 μm and less than or equal to about 6 μm, for example.

The dimension of the multilayer ceramic capacitor 110 including the multilayer body 112 and the outer electrodes 130 in the first direction y is defined as an L dimension. The L dimension is preferably greater than or equal to about 0.10 mm and less than or equal to about 3.50 mm, or more preferably greater than or equal to about 0.40 mm and less than or equal to about 2.20 mm, for example.

The dimension of the multilayer ceramic capacitor 110 including the multilayer body 112 and the outer electrodes 130 in the second direction z is defined as a T dimension. The T dimension is preferably greater than or equal to about 0.07 mm and less than or equal to about 3.00 mm, or more preferably, greater than or equal to about 0.25 mm and less than or equal to about 1.50 mm, for example.

The dimension of the multilayer ceramic capacitor 110 including the multilayer body 112 and the outer electrodes 130 in the lamination direction x is defined as a W dimension. The W dimension is preferably greater than or equal to about 0.05 mm and less than or equal to about 2.80 mm, or more preferably, greater than or equal to about 0.20 mm and less than or equal to about 1.45 mm, for example.

In the multilayer ceramic capacitor 110, the W dimension, or a dimension in the lamination direction x, is smaller than the T dimension in the second direction z.

In the multilayer ceramic capacitor 110 illustrated in FIG. 10, the first thickest point 130aP of the first outer electrode 130a is located, in the lamination direction x, closer to the first surface 112a or the second surface 112b with respect to the line m connecting the second thickest point 130bP of the second outer electrode 130b and the third thickest point 130cP of the third outer electrode 130c. The shortest distance d between the line m connecting the second thickest point 130bP of the second outer electrode 130b and the third thickest point 130cP of the third outer electrode 130c and the first thickest point 130aP of the first outer electrode 130a located closer to the first surface 112a or the second surface 112b in the lamination direction x is greater than or equal to about 50 μm. Thus, when the fifth surface 112e defines and functions as the mount surface and the thickest points define and function as the three points to be supported to mount the multilayer ceramic capacitor 10 on a mount board, the multilayer ceramic capacitor 110 reduces inclination and can thus be stably mounted while remaining nearly untilted.

A non-limiting example of a method for manufacturing this multilayer ceramic capacitor is described now. Hereinbelow, a method for manufacturing the multilayer ceramic capacitor 110 is described.

First, dielectric sheets and an electroconductive paste for an inner electrode are prepared. Ceramic green sheets and an electroconductive paste for an inner electrode include a binder (for example, a known organic binder) and a solvent (for example, an organic solvent).

Subsequently, a predetermined pattern is printed by, for example, screen printing or gravure printing on the dielectric sheets with the electroconductive paste for an inner electrode. Thus, dielectric sheets each carrying the pattern of a first inner electrode layer and dielectric sheets each carrying the pattern of a second inner electrode layer are prepared.

More specifically, gravure printing plates for printing the first inner electrode layers and the second inner electrode layers are prepared, and thus the inner electrode layers in the present invention can be printed.

To obtain an intended structure, the dielectric sheets on each of which the first inner electrode layer is printed and the dielectric sheets on each of which the second inner electrode layer is printed are alternately laminated to form a portion serving as a capacitance generating portion.

Thereafter, a predetermined number of dielectric sheets on which the patterns of the inner electrode layers are not printed are laminated to form a portion serving as the second outer layer portion 120b located closer to the second surface 112b. Thereafter, the portion serving as the capacitance generating portion 118 formed in the above process is laminated on the portion serving as the second outer layer portion 20b. Thereafter, a predetermined number of dielectric sheets on which the patterns of the inner electrode layers are not printed are laminated on a portion serving as the capacitance generating portion 118 to form the first outer layer portion 120a located closer to the first surface 112a. A multilayer sheet is manufactured in this manner.

Subsequently, the multilayer sheet is pressed in the lamination direction by a device such as an isostatic press to form a multilayer block.

The multilayer block is then cut into multilayer chips with a predetermined size. At this time, the corner portions and the ridgeline portions of the multilayer chips may be rounded by, for example, barrel finishing.

Each cut multilayer chip is then sintered to be formed into a multilayer body 112. Although depending on the material of the dielectric layers 114 or the inner electrode layers 116, the sintering temperature is preferably greater than or equal to about 900° C. and less than or equal to about 1400° C., for example.

Subsequently, the first base electrode layer 132a of the first outer electrode 130a, the second base electrode layer 132b of the second outer electrode 130b, and the third base electrode layer 132c of the third outer electrode 130c are formed on the fifth surface 112e of the multilayer body 112 obtained by sintering.

An electroconductive paste including a glass component and a metal component is applied, and then sintered to form a sintered layer serving as the base electrode layer 132. The temperature of the sintering process is preferably greater than or equal to about 700° C. and less than or equal to about 900° C., for example. In the present example embodiment, each base electrode layer 132 includes a sintered layer.

The sintered layers may be formed by a roller transfer method. To form, with the roller transfer method, the base electrode layer 132 in the first outer electrode on, not only the fifth surface 112e, but also a portion of the first surface 112a and a portion of the second surface 112b, the exerted pressure and the roller speed in roller transfer are adjusted to form the first thickest point on the fifth surface 112e while the location of the first thickest point is adjusted. Exerting a higher pressure in roller transfer enables forming the base electrode layer 132 on a portion of the first surface 112a and a portion of the second surface 112b. In addition, to form the base electrode layer 132 in the second outer electrode and the third outer electrode, the location or the size of the grooves of the roller that transfers the electroconductive paste are adjusted to form the base electrode layer 132 on a portion of the third surface 112c and a portion of the fourth surface 112d.

When the base electrode layer 132 is to be formed from an electroconductive resin layer, the electroconductive resin layer may be formed in the method below. The electroconductive resin layer may be on the surface of the sintered layer, or may be simply and directly on the multilayer body 112 without providing a sintered layer.

The method for forming an electroconductive resin layer includes applying an electroconductive resin paste including a thermosetting resin and a metal component to the sintered layer or the multilayer body 112, thermally processing the electroconductive resin paste at a temperature greater than or equal to about 250° C. and less than or equal to about 550° C., for example, and thermally curing the resin to form the electroconductive resin layer. An N2 atmosphere is preferable as the atmosphere during the thermal processing. In addition, to prevent scattering of the resin and oxidation of each metal component, preferably, the oxygen content is less than or equal to about 100 ppm, for example.

As in the method for forming the base electrode layer 132 from a sintered layer, the electroconductive resin paste may be applied by, for example, squeezing an electroconductive resin paste out of a slit or a roller transfer method.

The multilayer ceramic capacitor 110 according to the second example embodiment is manufactured in the above manner.

To check the advantageous effects of the above multilayer ceramic capacitors according to example embodiments of the present invention, multilayer ceramic capacitors were manufactured as test pieces of experiments, and the inclination of each test piece after the mount was measured.

With the manufacturing method according to the above example embodiment, multilayer ceramic capacitors included in multilayer ceramic electronic components serving as test pieces according to comparative examples and Example 1 to Example 8 were fabricated.

### Structure of Multilayer Ceramic Capacitor: Three Terminals (Refer to FIG. 1)

Dimension (L) of Multilayer Ceramic Capacitor: 1.22 mm
Dimension (W) of Multilayer Ceramic Capacitor: 0.92 mm
Dimension (T) of Multilayer Ceramic Capacitor: 0.48 mm
Dielectric Thickness of Capacitance generating portion: 0.48 μm
Thickness of First and Second Inner Electrode Layer: 0.40 μm
Number of First Inner Electrode Layers: 220
Number of Second Inner Electrode Layers: 220
Thickness of First and Second Outer Layer Portions: 30 μm
L Gap Dimension: 50 μm
W Gap Dimension: 50 μm
Structure of Inner Electrode
Structure of Outer Electrode
First Outer Electrode and Second Outer Electrode
Base Electrode Layer: Sintered Layer Including Electroconductive Metal (Cu) and Glass Component
Plating Layer: Two-Layer Structure Including Ni Plating Layer and Sn Plating Layer
Third Outer Electrode and Fourth Outer Electrode
Base Electrode Layer: Sintered Layer Including Electroconductive Metal (Cu) and Glass Component
Plating Layer: Two-Layer Structure Including Ni Plating

### Layer and Sn Plating Layer

Each test piece of the comparative examples was prepared as an existing multilayer ceramic capacitor in which a first thickest point and a second thickest point were located at the middle portions of the turn-up portions of the first outer electrode and the second outer electrode, and a thickest point was located at the middle portion of the third outer electrode.

Each test piece of the examples was prepared as a multilayer ceramic capacitor in which a third thickest point of the third outer electrode was located closer to the first surface or the second surface with respect to a line m connecting the first thickest point and the second thickest point of the turn-up portions of the first outer electrode and the second outer electrode.

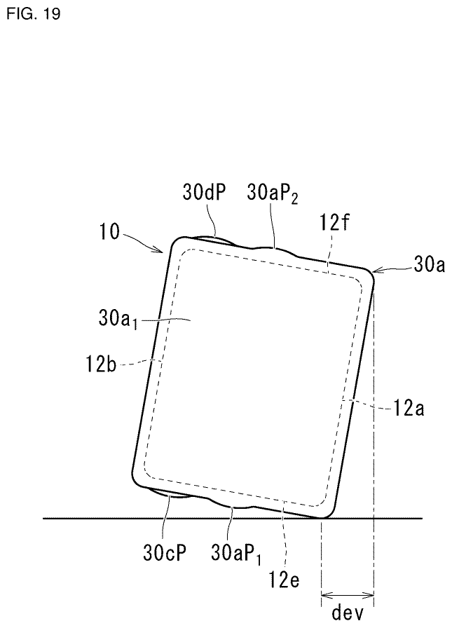

As an example, after each test piece of an example of an experiment was mounted by reflow on the mount board, the board underwent cross-sectional polishing to expose the cross section (WT cross section) taken along the lamination direction x and the second direction z, and an inclination dev was measured as illustrated in FIG. 19. The inclination dev was measured with, for example, a microscope (VHX-8000 from Keyence Corporation).

With a laser microscope, a first thickest point located at the first turn-up portion of the first outer electrode, a second thickest point located at the second turn-up portion of the second outer electrode, and a third thickest point located at the third outer electrode were specified. As illustrated in FIG. 2, a shortest distance d between the line m connecting the first thickest point and the second thickest point and the third thickest point was then measured. The shortest distance d was measured using a laser microscope (VK8700 from Keyence Corporation).

Table 1 shows the measurement results of the inclination dev of each test piece with respect to a change of the shortest distance d between the line m connecting the first thickest point and the second thickest point and the third thickest point.

TABLE 1

| | Comparative Example | | | Example | |
|---|---|---|---|---|---|
| | Shortest Distance | | | Shortest Distance | |
| | Between Line m | | | Between Line m | |
| | Connecting First | | | Connecting First | |
| | Thickest Point and | Inclination | | Thickest Point and | Inclination |
| Test | Second Thickest Point | of Test | Test | Second Thickest Point | of Test |
| Piece | and Third Thickest | Piece: dev | Piece | and Third Thickest | Piece: dev |
| Number | Point (μm) | (μm) | Number | Point (μm) | (μm) |
| 1 | 5 | 71 | 1 | 110 | 4 |
| 2 | 16 | 66 | 2 | 104 | 5 |
| 3 | 6 | 69 | 3 | 113 | 3 |
| 4 | 19 | 63 | 4 | 119 | 2 |
| 5 | 8 | 68 | 5 | 101 | 5 |
| 6 | 10 | 68 | 6 | 108 | 4 |
| 7 | 12 | 67 | 7 | 115 | 3 |
| 8 | 2 | 72 | 8 | 117 | 2 |
| 9 | 21 | 61 | 9 | 121 | 1 |
| 10 | 14 | 65 | 10 | 105 | 4 |
| Mean | 11.3 | 67.0 | Mean | 113.3 | 3.3 |

Table 1 shows that, test pieces according to Example 1 to Example 10 had a shortest distance d between the line m connecting the first thickest point and the second thickest point and the third thickest point greater than or equal to about 50 μm, and thus had a preferable inclination dev of less than or equal to about 5 μm, for example.

In contrast, test pieces according to Comparative Example 1 to Comparative Example 10 had a shortest distance d between the line m connecting the first thickest point and the second thickest point and the third thickest point less than or equal to about 50 μm, and thus had an inclination dev greater than or equal to 60 μm, which was larger than the inclination of the test pieces according to Examples.

The above results reveal that, when the shortest distance d between the line m connecting the first thickest point and the second thickest point and the third thickest point is greater than or equal to about 50 μm, for example, each multilayer ceramic capacitor is supported at three thickest points. Each test piece formed from, particularly, a through-connection multilayer ceramic capacitor mounted vertically thus has a reduced inclination.

Although the example embodiments of the present invention are described as above, the present invention is not limited to the example embodiments.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including a plurality of laminated dielectric layers, and a plurality of inner electrode layers laminated on the dielectric layers, the multilayer body including a first surface and a second surface opposing in a lamination direction, a third surface and a fourth surface opposing in a first direction orthogonal to the lamination direction, and a fifth surface and a sixth surface opposing in a second direction orthogonal to the lamination direction and the first direction;
a first inner electrode layer on the plurality of dielectric layers and extended to the third surface and the fourth surface;
a second inner electrode layer on the plurality of dielectric layers and extended to the fifth surface and the sixth surface;
a first outer electrode on the third surface and connected to the first inner electrode layer;
a second outer electrode on the fourth surface and connected to the first inner electrode layer;
a third outer electrode on the fifth surface and connected to the second inner electrode layer; and
a fourth outer electrode on the sixth surface and connected to the second inner electrode layer; wherein
the first outer electrode includes a first turn-up portion covering a portion of the fifth surface and a portion of the sixth surface;
the second outer electrode includes a second turn-up portion covering a portion of the fifth surface and a portion of the sixth surface;
the fifth surface or the sixth surface faces a board mount surface; and
in the multilayer ceramic capacitor:
(i) the first turn-up portion in the first outer electrode on the fifth surface includes a first thickest point or a thickest portion with a largest dimension in the second direction;
the second turn-up portion in the second outer electrode on the fifth surface includes a second thickest point or a thickest portion with a largest dimension in the second direction; and
the third outer electrode includes a third thickest point or a thickest portion with a largest dimension in the second direction; and
a shortest distance between a line connecting the first thickest point of the first turn-up portion and the second thickest point of the second turn-up portion and the third thickest point of the third outer electrode located closer to the first surface or the second surface in the lamination direction is greater than or equal to about 50 μm; and/or (ii) the first turn-up portion in the first outer electrode on the sixth surface includes a first thickest point or a thickest portion with a largest dimension in the second direction;
the second turn-up portion in the second outer electrode on the sixth surface includes a second thickest point or a thickest portion with a largest dimension in the second direction; and
the fourth outer electrode includes a fourth thickest point or a thickest portion with a largest dimension in the second direction; and
a shortest distance between a line connecting the first thickest point of the first turn-up portion and the second thickest point of the second turn-up portion and the fourth thickest point of the fourth outer electrode located closer to the first surface or the second surface in the lamination direction is greater than or equal to about 50 μm.

2. The multilayer ceramic capacitor according to claim 1, wherein
the first thickest point of the first turn-up portion is located at substantially a middle portion of the first turn-up portion;
the second thickest point of the second turn-up portion is located at substantially a middle portion of the second turn-up portion; and
each of the third thickest point of the third outer electrode and the fourth thickest point of the fourth outer electrode is located closer to the first surface or the second surface with respect to a midpoint of a dimension in the lamination direction.

3. The multilayer ceramic capacitor according to claim 1, wherein a dimension, in the lamination direction, of the multilayer body and the first outer electrode to the fourth outer electrode is smaller than a dimension, in the second direction, of the multilayer body and the first outer electrode to the fourth outer electrode.

4. The multilayer ceramic capacitor according to claim 3, wherein a largest thickness of each of the third outer electrode and the fourth outer electrode is greater than a largest thickness of each of the first turn-up portion and the second turn-up portion.

5. The multilayer ceramic capacitor according to claim 4, wherein each of the third outer electrode and the fourth outer electrode has an average thickness greater than an average thickness of each of the first turn-up portion and the second turn-up portion.

6. The multilayer ceramic capacitor according to claim 5, wherein
a dimension, in the first direction, of the multilayer body and the first outer electrode to the fourth outer electrode is greater than or equal to about 0.10 mm and less than or equal to about 3.50 mm; and
a dimension, in the lamination direction, of the multilayer body and the first outer electrode to the fourth outer electrode is greater than or equal to about 0.05 mm and less than or equal to about 2.80 mm.

7. The multilayer ceramic capacitor according to claim 5, wherein
a dimension, in the first direction, of the multilayer body and the first outer electrode to the fourth outer electrode is greater than or equal to about 0.40 mm and less than or equal to about 2.20 mm; and
a dimension, in the lamination direction, of the multilayer body and the first outer electrode to the fourth outer electrode is greater than or equal to about 0.20 mm and less than or equal to about 1.45 mm.

8. The multilayer ceramic capacitor according to claim 1, wherein the multilayer body has a rectangular or substantially rectangular prism shape.

9. The multilayer ceramic capacitor according to claim 1, wherein the multilayer body includes rounded corner portions or rounded ridgeline portions.

10. The multilayer ceramic capacitor according to claim 1, wherein protrusions or recesses are provided on a portion of or an entirety of the first surface, the second surface, the third surface, the fourth surface, the fifth surface, and the sixth surface.

11. A multilayer ceramic capacitor, comprising:
a multilayer body including a plurality of laminated dielectric layers, and a plurality of inner electrode layers laminated on the dielectric layers, the multilayer body including a first surface and a second surface opposing in a lamination direction, a third surface and a fourth surface opposing in a first direction orthogonal to the lamination direction, and a fifth surface and a sixth surface opposing in a second direction orthogonal to the lamination direction and the first direction;
a first inner electrode layer on the plurality of dielectric layers and extended to a middle portion of the fifth surface in the first direction;
a second inner electrode layer on the plurality of dielectric layers and extended to a first end portion and a second end portion of the fifth surface in the first direction;
a first outer electrode on the fifth surface, connected to the first inner electrode layer, and extending in the lamination direction;
a second outer electrode at the first end portion of the fifth surface in the first direction, connected to the second inner electrode layer, and extending in the lamination direction; and
a third outer electrode at the second end portion of the fifth surface in the first direction, connected to the second inner electrode layer, and extending in the lamination direction; wherein
the first outer electrode includes a first thickest point or a portion of the first outer electrode with a largest dimension in the second direction;
wherein the second outer electrode includes a second thickest point or a portion of the second outer electrode with a largest dimension in the second direction;
the third outer electrode includes a third thickest point or a portion of the third outer electrode with a largest dimension in the second direction; and
a shortest distance between a line connecting the second thickest point of the second outer electrode and the third thickest point of the third outer electrode and the first thickest point of the first outer electrode located closer to the first surface or the second surface in the lamination direction is greater than or equal to about 50 μm.

12. The multilayer ceramic capacitor according to claim 11, wherein
the first thickest point of the first outer electrode is located closer to the first surface or the second surface with respect to a midpoint of a dimension in the lamination direction;
the second thickest point of the second outer electrode is located at substantially a middle portion of the second outer electrode on the fifth surface; and
the third thickest point of the third outer electrode is located at substantially a middle portion of the third outer electrode on the fifth surface.

13. The multilayer ceramic capacitor according to claim 11, wherein a dimension, in the lamination direction, of the multilayer body and the first outer electrode to the third outer electrode is smaller than a dimension, in the second direction, of the multilayer body and the first outer electrode to the third outer electrode.

14. The multilayer ceramic capacitor according to claim 13, wherein a largest thickness of the first outer electrode is greater than a largest thickness of each of the second outer electrode and the third outer electrode.

15. The multilayer ceramic capacitor according to claim 14, wherein the first outer electrode has an average thickness greater than an average thickness of each of the second outer electrode and the third outer electrode.

16. The multilayer ceramic capacitor according to claim 15, wherein
a dimension, in the first direction, of the multilayer body and the first outer electrode to the third outer electrode is greater than or equal to about 0.10 mm and less than or equal to about 3.50 mm; and
a dimension, in the lamination direction, of the multilayer body and the first outer electrode to the third outer electrode is greater than or equal to about 0.05 mm and less than or equal to about 2.80 mm.

17. The multilayer ceramic capacitor according to claim 15, wherein
a dimension, in the first direction, of the multilayer body and the first outer electrode to the third outer electrode is greater than or equal to about 0.40 mm and less than or equal to about 2.20 mm; and
a dimension, in the lamination direction, of the multilayer body and the first outer electrode to the third outer electrode is greater than or equal to about 0.20 mm and less than or equal to about 1.45 mm.

18. The multilayer ceramic capacitor according to claim 11, wherein the multilayer body has a rectangular or substantially rectangular prism shape.

19. The multilayer ceramic capacitor according to claim 11, wherein the multilayer body includes rounded corner portions or rounded ridgeline portions.

20. The multilayer ceramic capacitor according to claim 11, wherein protrusions or recesses are provided on a portion of or an entirety of the first surface, the second surface, the third surface, the fourth surface, the fifth surface, and the sixth surface.
